(19) United States
(12) Patent Application Publication
(10) Pub. No.: US 2024/0063618 A1
(43) Pub. Date: Feb. 22, 2024

(54) ELECTRICAL COMPONENT HANGERS

(71) Applicant: Hubbell Incorporated, Shelton, CT (US)

(72) Inventors: Joshua Martin Baynard, Columbia, SC (US); Greg Patrick Roccapriore, Bath, NH (US)

(21) Appl. No.: 18/197,599

(22) Filed: May 15, 2023

Related U.S. Application Data
(63) Continuation-in-part of application No. 29/850,677, filed on Aug. 22, 2022.
Application No. 29/850,677 is a continuation-in-part of application No. 29/883,447, filed on Jan. 30, 2023.
(60) Provisional application No. 63/400,007, filed on Aug. 22, 2022.
(60) Provisional application No. 63/425,213, filed on Nov. 14, 2022.
(60) Provisional application No. 63/441,893, filed on Jan. 30, 2023.

(51) Int. Cl. H02G 3/04; F16L 3/06; F16L 3/12; F16L 3/24; F16L 3/23; F16L 3/127

(52) U.S. Cl. CPC H02G 3/0456; F16L 3/06; F16L 3/1218; F16L 3/243; F16L 3/23; F16L 3/127

(57) ABSTRACT

An electrical component hanger for securing at least one electrical component to a structure, the electrical component hanger including at least one connector portion for securing the electrical component hanger to a structure and a pair of electrical component receiving portions extending from the at least one connector portion for receiving at least one electrical component to be secured.

### CROSS-REFERENCE TO RELATED APPLICATIONS

This application is based on and claims priority to U.S. Provisional Application Ser. No. 63/400,007 filed Aug. 22, 2022 entitled ELECTRICAL COMPONENT HANGERS and U.S. Provisional Application Ser. No. 63/425,213 filed Nov. 14, 2022 entitled ELECTRICAL COMPONENT HANGERS and U.S. Provisional Application Ser. No. 63/441,893 filed Jan. 30, 2023 entitled ELECTRICAL COMPONENT HANGERS and is a Continuation-in-part of U.S. Design application Ser. No. 29/850,677 filed Aug. 22, 2022 entitled ELECTRICAL COMPONENT HANGERS and U.S. Design application Ser. No. 29/883,447 filed Jan. 30, 2023 entitled ELECTRICAL COMPONENT HANGERS the contents of each of which are incorporated herein in their entirety by reference.

### BACKGROUND

### Field

The present disclosure relates generally to hangers and more specifically, to electrical component hangers.

### Description of the Related Art

Structures are often provided for supporting different types of systems which may include electrical systems, electrical components, cabling or wiring, etc. Often, electrical cabling or wiring is run to and from various parts of these systems utilizing one or more types of cable management systems.

For example, the use of photovoltaic arrays to provide electrical power in commercial, residential, and other environments has become more and more popular. Photovoltaic arrays are generally composed of a number of photovoltaic modules and may be set within a support structure such as a metallic frame or rail system that supports the photovoltaic modules. The frame or rail system is attached to a structure such as a roof or the ground. When installing a photovoltaic array, a number of photovoltaic modules are assembled onto the frame or rail system. The metallic frames of the individual photovoltaic modules, and the structural pieces, e.g., the rails, on which the modules are mounted are generally made out of aluminum. Depending upon the size of the photovoltaic array, the rail system may include multiple metallic rails coupled or connected together in a grid-like pattern. To prevent shadowing on the solar panels, it is important that electrical components including wires, cables, connectors, fuses, etc. remain away from the light receiving faces of the solar panels. This can be particularly difficult when solar panels which allow light to enter from the back and front (e.g., bi-facial installation) are utilized, since the wires and/or electrical components tend to hang or drape from the array, even when existing cable management systems are used. To ensure the integrity of wires running along the metal frames of the photovoltaic modules, the wires may be mounted to the metal frames using one or more of various types of wire management systems. The wire management systems provide neat, easy and efficient ways for connecting the wires to the support structure. Examples of wire management systems include various types of clips as well as various types of ties including twist ties, zip ties, hook and loop ties, crimped wire cable ties etc.

The wire management systems are generally limited in size based on the size of the wire that is going to be supported. For example, clips for attaching a wire to a rail are generally dimensioned to receive one or more wires having particular diameters to insure a positive connection. That is, if the opening of the clip is too large, the wire may fall from the clip or otherwise sag. If the opening is too small, the user may be limited to the wire that can be supported or in worse case, the wires may become crimped, broken or chafed exposing bare wire and requiring time consuming and expensive troubleshooting and repairs. The various types of ties being utilized provide limited support such that the wires still move and sag.

Often, one or more other electrical components may be provided in line (e.g., in series or in parallel) with the wiring. Examples of such electrical components may include fuses, electrical filters, capacitors, resistors, rectifiers, etc. as well as the wires themselves. These electrical components are generally bulky and are made more so when they are manufactured with one or more layers of waterproof coatings to protect them from the environment. When these electrical components are allowed to hang loosely, they may put additional stresses on the wires to which they are connected. Furthermore, the wires which sag under their own weight tend to sag even further under the additional weight of the electrical components and can cause shadowing on the photovoltaic modules.

These electrical components are generally too large to be clipped into the same clips as the wires. Utilizing one of more of the various types of ties to mount the electrical component to the structure results in an awkward, time-consuming installation and only provides an inefficient flimsy solution to the problem.

A need exists for hangers for securely and reliably hanging and holding electrical components to various types of structures.

### SUMMARY

The present disclosure provides embodiments of electrical component hangers for securing electrical components to structures.

According to an exemplary embodiment, an electrical component hanger for securing an electrical component to a structure includes at least one connector portion for securing the electrical component hanger to a structure and an electrical component receiving portion extending from the at least one connector portion for receiving an electrical component to be secured.

According to another exemplary embodiment, an electrical component hanger for securing an electrical component to a structure includes a segment of spring steel including a pair of distal ends and a middle section, the distal ends capable of deflecting and returning to an original position for securing the electrical component hanger to a structure. The middle section forms an electrical component receiving section for receiving the electrical component to be secured.

According to another exemplary embodiment, an electrical component management system includes a segment of spring steel rod including a pair of distal end portions and a middle portion, the distal end portions bent at substantially right angles to arms extending therefrom, the distal end portions flaring in an outward direction, the pair of distal end portions capable of being pressed towards each other and returning to original positions. The middle section of the segment of spring steel rod is bent into a shape for receiving and securing an electrical component, the shape comprising at least one of a circular, square, rectangular, etc. shape. The arms extending from the distal end portions are different lengths such that the distal end portions of the segment of spring steel rod overlap when brought together.

An electrical component management system includes a segment of spring steel rod including a pair of distal end portions, a middle portion and arm portions extending from the distal end portions to the middle portion, the distal end portions bent at substantially right angles to arms extending therefrom, the distal end portions flaring in an outward direction, the pair of distal end portions capable of being pressed towards each other and returning to original positions. The arm portions are bent into a shape for receiving and securing an electrical component, the shape comprising at least one of a circular, square, rectangular, etc. shape. The middle portion includes a substantially U-shaped bend and the arms are different lengths such that when the arm portions are brought together the distal end portions overlap.

An electrical component hanger for securing an electrical component to a structure, the electrical component hanger including a segment of spring steel having a pair of distal ends and a middle section, the distal ends capable of deflecting and returning to an original position for securing the electrical component hanger to a structure. The middle section forms an electrical component receiving section for receiving the electrical component to be secured and the pair of distal ends extend in a direction substantially perpendicular to a plane formed by the middle section.

An electrical component hanger for securing an electrical component to a structure, the electrical component hanger including a segment of spring steel having a pair of distal ends and a middle loop section, the distal ends capable of deflecting and returning to an original position for securing the electrical component hanger to a structure. The middle loop section forms an electrical component receiving section for receiving one or more electrical components and includes at least one secondary loop section for securing one or more electrical components to be secured.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a perspective view of an electrical component hanger according to an illustrative embodiment of the present disclosure;

FIG. 2 is a side view of the electrical component hanger according to the illustrative embodiment of the present disclosure depicted in FIG. 1;

FIG. 3 is side view of the electrical component hanger according to the illustrative embodiment of the present disclosure depicted in FIG. 1, for describing various aspects of the present embodiment.

FIG. 4 is a perspective view of the electrical component hanger according to the illustrative embodiment of the present disclosure depicted in FIG. 1 for describing attaching an electrical component and component hanger to a structure.

FIG. 5 is a perspective view of an electrical component hanger according to another illustrative embodiment of the present disclosure;

FIG. 6 is a front view of the electrical component hanger according to the illustrative embodiment of the present disclosure depicted in FIG. 5;

FIG. 7 is a side view of the electrical component hanger according to the illustrative embodiment of the present disclosure depicted in FIG. 5.

FIGS. 8 and 9 are partial front views for describing how the electrical component hangers according to illustrative embodiments of the present disclosure are mounted to a structure:

FIG. 10 is a perspective view of an electrical component hanger according to another illustrative embodiment of the present disclosure;

FIG. 11 is a front view of the electrical component hanger according to the illustrative embodiment of the present disclosure depicted in FIG. 10;

FIGS. 12A-12C are top views for describing various embodiments of electrical component hangers according to illustrative embodiments of the present disclosure;

FIG. 12D is a side view for describing an embodiment of an electrical component hanger according to an illustrative embodiment of the present disclosure;

FIG. 13, is a side view of the electrical component hanger according to the illustrative embodiment of the present disclosure depicted in FIG. 10;

FIG. 14 is an enlarged partial view for describing how the electrical component hangers described herein are mounted to a structure;

FIG. 15 is a perspective view of an electrical component hanger according to an illustrative embodiment of the present disclosure including a coating;

FIGS. 16A-16C are views for describing electrical component hangers according to various illustrative embodiments of the present disclosure;

FIG. 17 is a view for describing attaching an electrical component hanger according to embodiments of the present disclosure to a structure utilizing an intermediate connection;

FIG. 18 is a view for describing attaching an electrical component hanger according to embodiments of the present disclosure to a structure utilizing an intermediate connection;

FIG. 19 is a view for describing attaching an electrical component hanger according to embodiments of the present disclosure to a structure using an intermediate connection;

FIG. 20 is front view for describing an electrical component hanger according to an illustrative embodiment of the present disclosure;

FIG. 21 is side view for describing the electrical component hanger according to the illustrative embodiment of the present disclosure depicted in FIG. 20;

FIG. 22 is perspective view for describing the electrical component hanger according to the illustrative embodiment of the present disclosure depicted in FIG. 20;

FIG. 23 is a top view for describing the electrical component hanger according to the illustrative embodiment of the present disclosure depicted in FIG. 20;

FIG. 24 is an enlarged partial view for describing attaching the electrical component hanger depicted in FIG. 20 to a structure;

FIG. 25A-25F are side views for describing various electrical component hangers according to illustrative embodiments of the present disclosure;

FIG. 26A is a front view of an electrical component hanger according an illustrative embodiment of the present disclosure;

FIGS. 26B, 26C are top views of alternative illustrative embodiments of the electrical component hanger depicted in FIG. 26A;

FIG. 26D is a side view of an electrical component hanger according to the illustrative embodiment of the present disclosure depicted in FIG. 26A;

FIG. 27A is a front view of an electrical component hanger according an illustrative embodiment of the present disclosure;

FIGS. 27B, 27C are top views of alternative illustrative embodiments of the electrical component hanger depicted in FIG. 27A;

FIGS. 28A-28E are front views of electrical component hangers according to illustrative embodiments of the present disclosure;

FIG. 29 is a front view of an electrical component hanger according to an illustrative embodiment of the present disclosure;

FIGS. 30A-30D are various views of an electrical component hanger according to an illustrative embodiment of the present disclosure;

FIGS. 31A-31F are various views for describing how electrical component hangers are attached to a bracket or frame according to illustrative embodiments of the present disclosure;

FIG. 32 is an electrical component hanger according to an illustrative embodiment of the present disclosure;

FIG. 33 is a perspective view of an electrical component hanger according to an illustrative embodiment of the present disclosure;

FIG. 33A is a perspective view of a portion of an electrical component hanger according to an illustrative embodiment of the present disclosure;

FIG. 34 is a front view of the electrical component hanger according to the illustrative embodiment of the present disclosure depicted in FIG. 33;

FIGS. 35A, 35B are top views of various embodiments of the electrical component hanger according to the illustrative embodiment of the present disclosure depicted in FIG. 33;

FIG. 35C is a side view of the electrical component hanger according to the illustrative embodiment of the present disclosure depicted in FIG. 33;

FIG. 36 is a perspective view of the electrical component hanger according to the illustrative embodiment of the present disclosure depicted in FIG. 33 attached to a structure;

FIG. 37 is a perspective view of an electrical component hanger according to an illustrative embodiment of the present disclosure;

FIG. 38A, 38B are top views of various embodiments of the electrical component hanger according to the illustrative embodiment of the present disclosure depicted in FIG. 37;

FIG. 38C is a side view of the electrical component hanger according to the illustrative embodiment of the present disclosure depicted in FIG. 37;

FIG. 39 is a perspective view of the electrical component hanger according to an illustrative embodiment of the present disclosure;

FIG. 40 is a front view of the electrical component hanger according to the illustrative embodiment of the present disclosure depicted in FIG. 39;

FIG. 41 is a top view of the electrical component hanger according to the illustrative embodiment of the present disclosure depicted in FIG. 39;

FIG. 42 is a side view of the electrical component hanger according to the illustrative embodiment of the present disclosure;

FIG. 43 is a perspective view of the electrical component hanger according to the illustrative embodiment of the present disclosure depicted in FIG. 39 attached to a structure; and

FIGS. 44A-44C are side view of electrical component hangers according to illustrative embodiments of the present disclosure.

### DETAILED DESCRIPTION

The present disclosure provides embodiments of electrical component hangers or supports for securing electrical components to a structure. By way of examples only, embodiments of the present disclosure will be described as being attached to a support structure such as a metal frame or rail upon which a photovoltaic panel or array may be mounted. For ease of description, the support structure may be referred to interchangeably herein as frame or rail. The electrical components to be secured to the electrical component hangers are described by way of example only and are not intended to be limiting. The electrical components to be secured to the electrical component hangers may be connected to one or more cables. The cables may be formed by one or more solid conductors or by one or more stranded conductors. The electrical component may be connected in series or in parallel with the one or more cables, depending on a particular application and may be covered or overmolded with, for example, plastic, rubber or other material to prevent any moisture/physical damage to the electrical component and connection. Non-limiting examples of electrical components may include wires, cables, connectors as well as fuses, electrical filters, capacitors, resistors, rectifiers, etc. connected to such wires, cables and/or various types of holders for removably or permanently holding such electrical components. The electrical components and/or holders may be coated or otherwise protected from the environment including rain, snow, ice, heat, etc.

The present disclosure also describes embodiments of electrical component hangers or supports as being attached directly to the structure or indirectly via one or more intermediate connection components.

Exemplary embodiments of the present disclosure will be described as being formed from a material capable of assuming a particular shape and substantially retaining that shape. The material may be referred to herein as wire, strip, sheet, etc. A non-limiting example of such material is spring steel. The spring steel may be in the form of a wire or rod having a substantially circular cross-section, although other cross-sectional shapes are contemplated. Alternatively, the spring steel may be in the form of a strip or sheet having a substantially rectangular cross-section. The spring steel may be coated with a suitable material to protect it from the environment. For example, the spring steel may be galvanized. Alternatively, other forms of environmentally protected materials such as stainless spring steel may be utilized. One or more portions of the material may be provided with a coating which is non-conductive and/or provides a higher coefficient of friction than the material itself. The gauge of the material is selected to be suitable for the shape and/or size of the electrical component to be held and generally may range between 6-18 gauge. While the following descriptions may refer to component hangers being made from one section or segment of wire, it will be appreciated the one section or segment might actually be formed from multiple sections or segments joined utilizing any known method of joining two or more sections of wire including but not limited to, for example, welding, twisting, gluing, compression, etc.

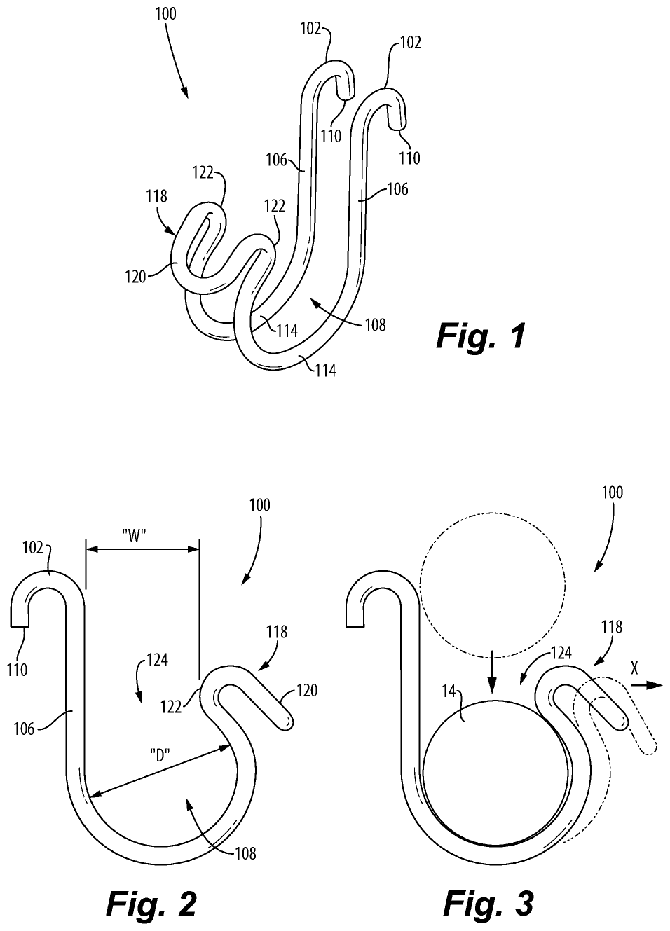

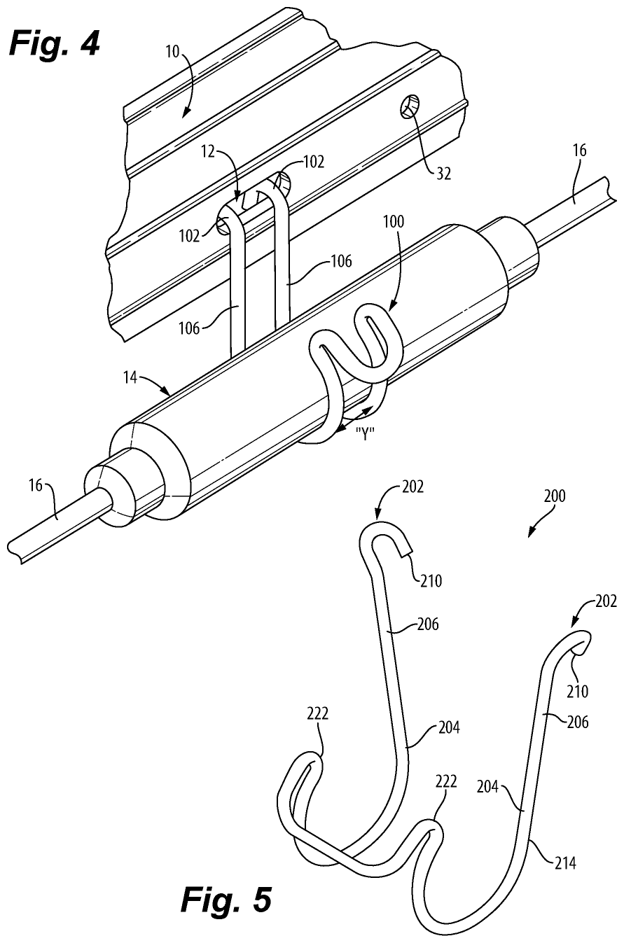

Referring to FIGS. 1-4, an exemplary embodiment of the present disclosure is referred to generally as electrical component hanger or simply hanger 100. In this exemplary embodiment, the hanger 100 is formed from a single segment of wire 114. Wire 114 may have a substantially circular cross section, although other cross-sectional shapes including square, rectangular, octagonal, etc. are also contemplated. The end sections of wire 114 terminate in ends 110 and are bent in a substantially “U” shape to form hook ends 102 as shown in FIG. 1. Arms 106 extend from end sections 102 and bend to form component holding section 108 and clip return section 118 and finally loop section 120. As shown in FIG. 2, component holding section 108 is substantially circular having a diameter “D” and is dimensioned to receive and secure an electrical component such as, for example, a fuse or cable connector. Diameter “D” may be the same or slightly smaller than the diameter of the electrical component being received, thus providing a snug and secure fit. Generally, the diameter of the electrical components to be held may be in the ¼ inch to 6 inch range. Wire 114 forming component holding section 108 extends to clip return section 118 and finally loop section 120. The rounded edge 122 of clip return section 118 allows the electrical component to be easily slid into place in component holding section 108 and prevents binding on any sharp edges. According to the present illustrative embodiment, at rest the width “W” of the gap 124 between arms 106 and rounded edges 122 may be smaller than diameter “D” of the component holding section 108 and/or the diameter of the electrical component being inserted into component holding section 108. As described by reference to FIGS. 2 and 3, by pressing the electrical component 14 into the gap 124, clip section 118 will move outwardly in direction X thus expanding the gap 124 and then return inwardly when the component 14 is properly seated in component holding section 108 (see FIG. 3). As shown in FIG. 4, an electrical component 14 connected in line or in parallel with wire 16 can be held firmly and securely in place in component hanger 100. Hook ends 102 can be easily hooked into slotted holes 12 or holes 32 formed in a rail or frame 10 to provide a neat secure electrical component holder. The width “Y” of the hanger may vary depending on the length of the electrical component or components to be held and may be in the ½ inch to 6 inch range.

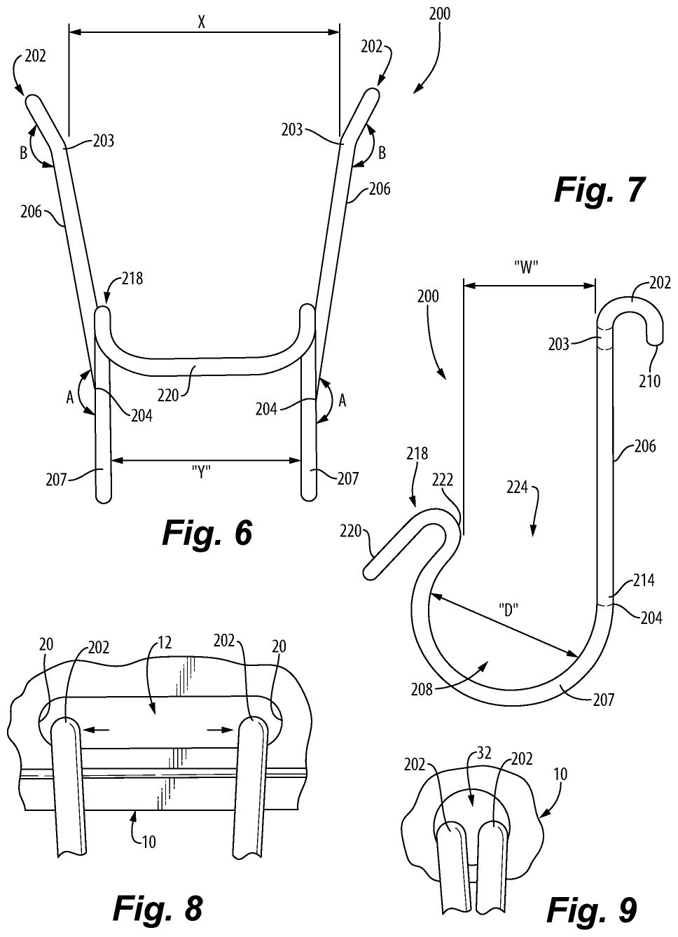

An electrical component hanger 200 according to another exemplary embodiment of the present disclosure is shown in FIGS. 5-9. Hanger 200 is formed from a single section of wire 214 having a substantially circular cross section, although as described above other cross-sectional shapes are contemplated. The end sections of wire 214 terminate in ends 210 and are bent in a substantially “U” shape to form hook ends 202 as shown in FIG. 5. The hook ends 202 flare outwardly from arms 206 at an angle “B” at elbows 203 as shown in FIG. 6. Angle “B” may generally be between 45-225 degrees and is preferably an obtuse angle between approximately 90-180 degrees. Arms 206 extend from hook ends 202 and bend at elbows 204 to circular section 207 forming component holding sections 208. According to this embodiment, arms 206 may also flare outwardly. For example, as shown in FIG. 6, arms 206 may flare outwardly at an angle “A” at elbows 204. Angle “A” may generally be between 90-225 degrees and is preferably an obtuse angle between approximately 90-180 degrees. As shown in FIG. 7, component holding section 208 is substantially circular having a diameter “D” and is dimensioned to receive and secure an electrical component such as, for example, a fuse or cable connector. Diameter “D” may be the same or slightly smaller than the diameter of the electrical component being received, providing a snug and secure fit. The portions 207 of wire 214 forming component holding section 208 extend to clip return section 218 and finally loop section 220. The rounded edge 222 of clip return section 218 allows the electrical component to be easily slid into place in component holding section 208 and prevents binding on any sharp edges. According to the present illustrative embodiment, at rest the width “W” of the gap 224 between arms 206 and rounded edge 222 may be smaller than diameter “D” of the component holding section 208 and/or the diameter of the electrical component being inserted into component holding section 208. By pressing the component into the gap 224, clip return section 218 will move outwardly expanding the gap 224 and then return inwardly when the component is properly seated in component holding section 208. Referring to FIGS. 6-9, at rest, the width “X” between hook end sections 202 is generally wider than the width of a slotted hole 12 or the diameter of rounded hole 32 in the frame or rail 10 to which the hanger 200 is to be attached. According to an embodiment of the present disclosure, the width “Y” may vary depending on a number of factors including, for example the length of the electrical component or components to be held and may be in the ½ inch to 6 inch range. Hook end sections 202 can be brought together by squeezing arms 206 towards each other and easily hooked into slotted hole 12 (FIG. 8) or hole 32 (FIG. 9) formed in the frame or rail 10. When the arms 206 are then released, the hook end sections 202 expand outwardly due to the spring steel action and press against the sides 20 of the holes preventing movement of the hanger 200. The hanger 200 thus provides a neat secure electrical component hanger.

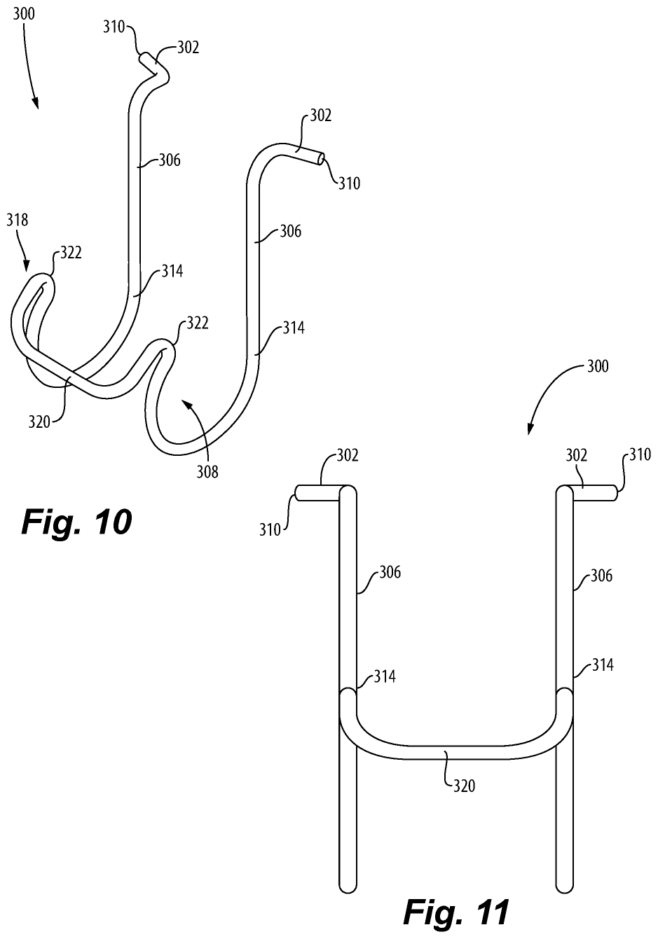

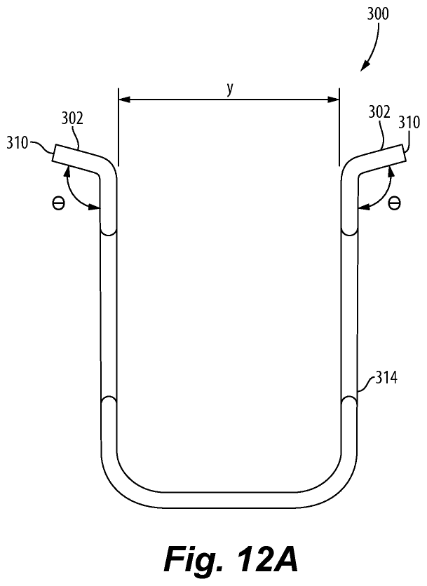

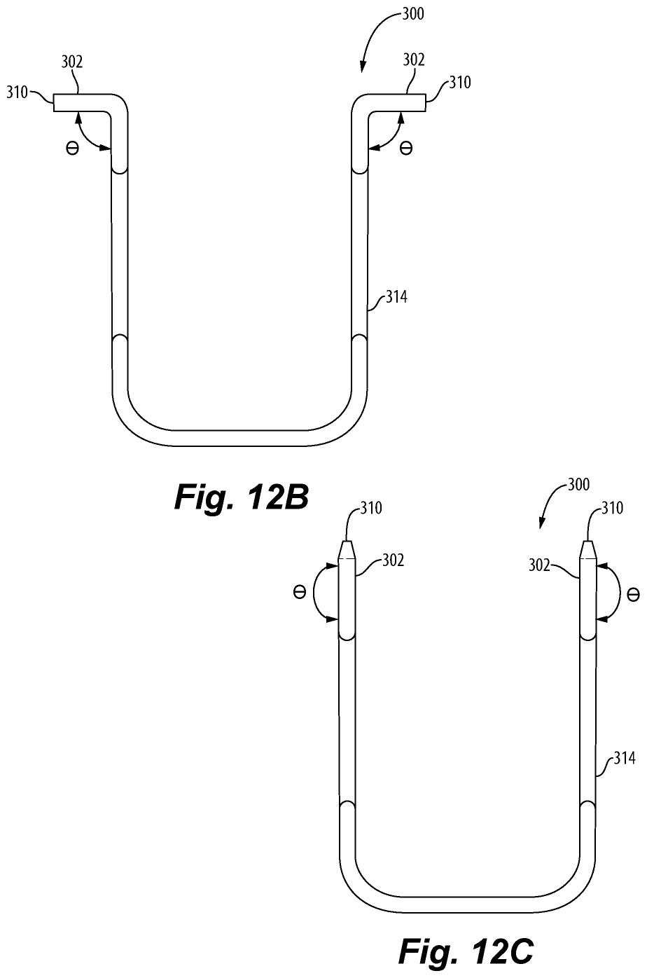

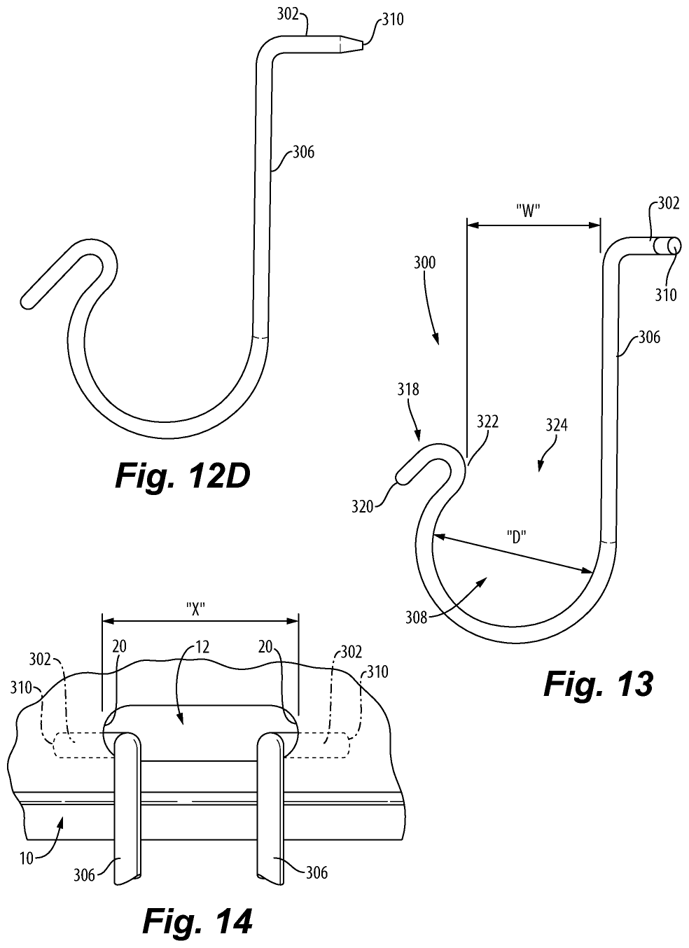

An electrical component hanger or hanger 300 according to another exemplary embodiment of the present disclosure is shown in FIGS. 10-14. Hanger 300 is formed from a single segment of wire 314 having a substantially circular cross section, although as described herein with respect to all other embodiments, other cross-sectional shapes are contemplated. The end sections of wire 314 terminate in distal ends 310 and are bent outwardly forming hook ends 302. As best shown in FIG. 12A, hook ends 302 may also flare back at an angle θ. Depending on a particular application, the angle θ may be between approximately 0 degrees and approximately 180 degrees. For example, as shown in FIG. 12B, hook ends 302 may extend to the sides at an acute angle θ of 90 degrees (or less). Alternatively, as shown in FIG. 12C, hook ends 302 may extend straight back at an obtuse angle θ of approximately between 90 and 180 degrees (or more). The hook ends 302 may also taper toward distal ends 310 as shown in FIGS. 12C and 12D. Arms 306 extend from hook ends 302 and bend to form component holding section 308. As shown in FIG. 13, component holding section 308 is substantially circular having a diameter “D” and is dimensioned to receive and secure an electrical component such as, for example, a fuse or cable connector. Diameter “D” may be the same or slightly smaller than the diameter of the electrical component being received, providing a snug and secure fit. Wire 314 forming component holding section 308 extends to clip return section 318 and finally loop section 320. The rounded edge 322 of clip return section 318 allows the electrical component to be easily slid and clipped into place in component holding section 308 and prevents binding on any sharp edges. According to the present illustrative embodiment, the width “W” of the gap 324 between arms 306 and rounded edges 322 while at rest may be smaller than diameter “D” of the component holding section 308 and/or the diameter of the electrical component being inserted into component holding section 308. By pressing the electrical component into the gap 324, clip return section 318 will move outwardly expanding the gap 324 and then return inwardly when the component is properly seated in component holding section 308 securing the electrical component in place. Referring to FIGS. 12A and 14, at rest, the distance between hook ends 302 is “Y” and is generally wider than width “X” of a slotted hole 12 in a rail 10 to which the hanger 300 is to be attached. According to embodiments of the present disclosure, the width “Y” may vary depending on the length of the electrical component or components to be held and may be in the ½ inch to 6 inch range. Hook ends 302 of hanger 300 can be brought together by squeezing arms 306 towards each other and then hooked into holes 12 formed in the rail 10. When the arms 306 are then released, the hook ends 302 expand outwardly due to the action of the spring steel and press against the sides 20 of hole 12 thus securing the hanger 300 to the rail 10. The hook ends 302 which flare back at an angle θ as shown in FIG. 12A make it substantially easier for the installer to insert the hook ends 302 into the holes 12 in the rail 10. The hanger 300 thus provides a neat, convenient and secure electrical component hanger.

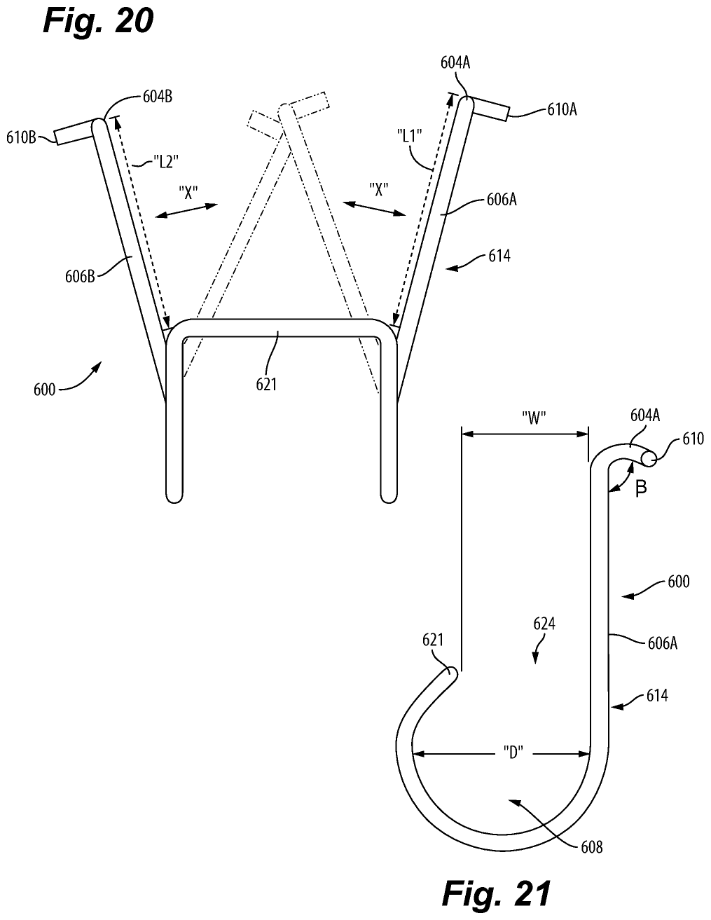

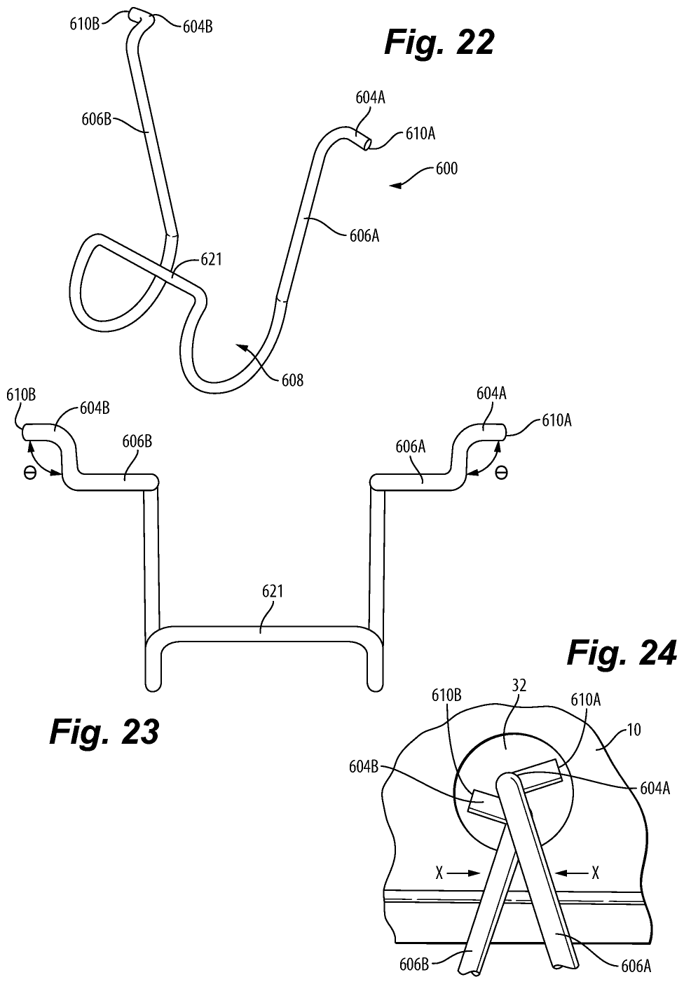

An electrical component hanger according to another illustrative embodiment of the present disclosure is depicted in FIGS. 20-24 and is referred to generally as hanger 600. Hanger 600 is formed from a single segment of wire 614 having a substantially circular cross section, although other cross-sectional shapes are contemplated. The hook end sections 604A, 604B of wire 614 terminate in distal end hook portions 610A, 610B. As best shown in FIG. 23, the distal end hook portions 610A, 610B are bent outwardly at an angle θ. According to this embodiment, the angle θ is approximately 90 degrees. Depending on a particular application, the distal end hook portions 610A, 610B may be bent at an angle θ which is less than or greater than 90 degrees as described above with respect to FIGS. 12A-12C. Arms 606A, 606B extend from hook end sections 604A, 604B and bend to form component holding section 608. Arms 606A, 606B flare outwardly as shown in FIGS. 20, 22. As shown best in FIG. 21, hook end sections 604A, 604B are bent at an angle β with respect to arms 606A, 606B, respectively which in this embodiment is substantially 90 degrees. Depending on a particular application, angle β may be greater than or less than 90 degrees. Component holding section 608 is substantially circular having a diameter “D”, although as described with respect to other embodiments, component holding section 608 may assume other shapes. Component holding section 608 is dimensioned to receive and secure an electrical component such as, for example, a fuse or cable connector. Diameter “D” may be the same or slightly smaller than the diameter of the electrical component being received, providing a snug and secure fit. Wire 614 forming component holding section 608 extends to loop section 621. Since the present embodiment does not include a clip return section (e.g., see components 118, 218, 318 as depicted in FIGS. 1-13), the hanger 600 can be made using substantially less material and because less bends of the wire 614 are required, the present embodiment is simpler and cheaper to manufacture than previous embodiments. According to the present illustrative embodiment, as depicted in FIG. 21, at rest the width “W” of the gap 624 between arms 606A, 606B and loop section 621 may be smaller than diameter “D” of the component holding section 608 and/or the diameter of the electrical component being inserted into component holding section 608. By pressing the electrical component into the gap 624, loop section 621 will move outwardly expanding the width “W” of gap 624 and then return inwardly when the component is properly seated in component holding section 608. The rounded shape of wire 614 at loop section 621 extending into gap 624 provides a smooth surface to prevent binding on any sharp edges. The lengths of arms 606A, 606B may be the same or different. For example, according to the illustrative embodiment depicted in FIG. 20, the length “L2” of arm 606B is less than a length “L1” of arm 606A. According to an embodiment of the present disclosure, arm 606B is shorter than arm 606A by approximately the diameter of the wire 614 forming the hanger 600. For example, assuming the wire 614 has a diameter of “d”, the length of the shorter arm 606B is “L2” and the length of the longer arm 606A is “L1”, the length “L2” of the shorter arm 606B=“L1”−“d”. Since arm 606B is shorter than arm 606A, when the two arms are squeezed together as depicted in phantom lines in FIG. 20 and in FIG. 24, hook end section 604B is able to move “under” or overlap hook end section 604A such that the hook end sections 604A, 604B are able to fit more easily into a relatively smaller hole 32. To attach hanger 600 to a frame 10, for example, arms 606A, 606B are squeezed together until hook end sections 604A, 604B overlap as shown in FIG. 24. Distal end hook portion 610A is first placed in the hole 32 followed by the distal end hook portion 610B. When the arms 606A, 606B are then released and attempt to return to the at rest positions depicted in FIG. 20 under action of the spring steel 614, the hook end sections 604A, 604B will be secured in hole 32. It will be appreciated that an embodiment may be provided in which the longer arm and shorter arm may be swapped to opposite sides without departing from the spirit and scope of the present disclosure and will function equally well as the above-described embodiment.

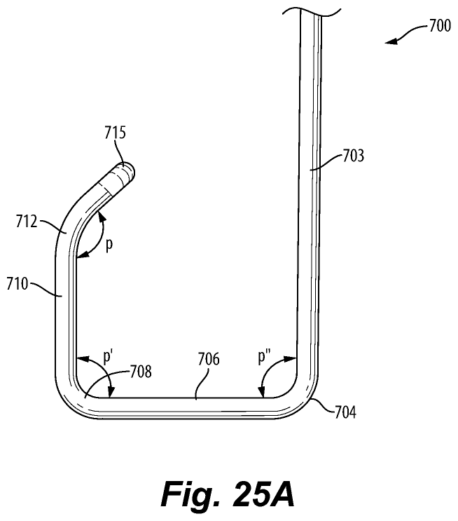

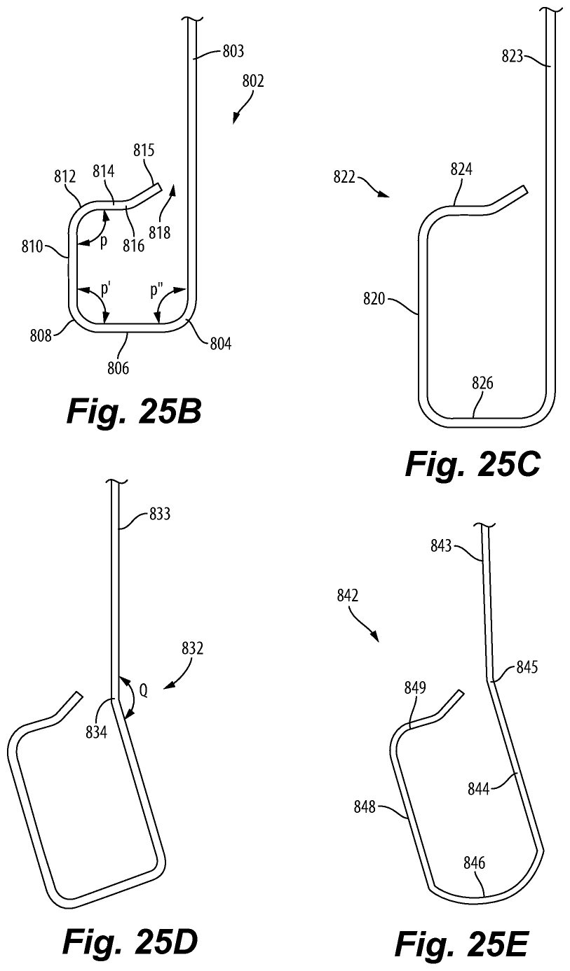

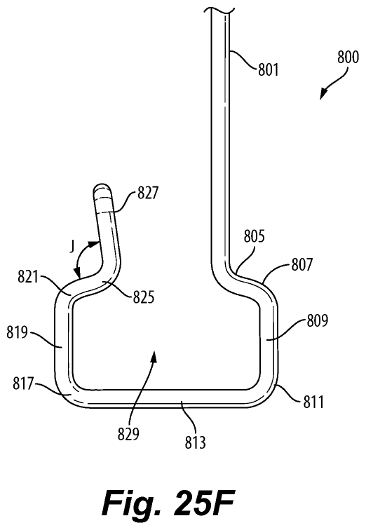

Illustrative embodiments of electrical component hangers have been described with the component holding sections (e.g., sections 108, 208, 308, etc) as substantially circular by way of example only for holding electrical components substantially circular in cross section. It will be appreciated the component holding sections may assume other shapes suitable for holding electrical components having circular cross sections as well as other cross-sectional shapes. According to other illustrative embodiments of the present disclosure, the component holding sections may be generally polygonal in shape having any suitable number of sides and may include one or more nonlinear curved sides. Portions of electrical component hangers according to other illustrative embodiments of the present disclosure are illustrated in FIGS. 25A-25F. Only the lower or electrical component holding portions or sections of the hangers are depicted. The upper ends or hook ends that attach the electrical component hanger to a structure as well as the portions of the arms extending up from the component holding sections may assume any of the configurations described in the present disclosure.

FIG. 25A depicts a component holding section 700 which is relatively square or rectangular. While still capable of holding one or more electrical components substantially circular in cross section, such configuration would also be suitable for holding one or more electrical component having, for example, a square, rectangular, triangular, oval or oblong, etc. cross-sectional shapes or combinations thereof. Of course, other different suitably shaped geometries are contemplated. The electrical component receiving and holding portion 700 has arm sections 703 that extend from the upper ends or hook ends to elbows 704, arms 706, elbows 708, arms 710, elbows 712 and return loop section 715. While not shown in detail for reasons of brevity, loop section 715 may be similar to any of the loop sections depicted and described in embodiments of the present disclosure (e.g., loop sections 120, 220, 320, 621, etc.). As described herein, the loop sections provide smooth rounded surfaces at the openings to the component receiving and holding portions of the hangers so that when the electrical component or components are passed through the opening and received in the component holding section, the cables are not nicked or otherwise damaged. Angles P′ and P″ are generally 90 degrees. Angle P may be between 0-360 degrees and preferably between 45-270 degrees and more preferably between 90-225 degrees.

The number of sides forming the electrical component section may vary. For example, a portion of an electrical component hanger according to another illustrative embodiment of the present disclosure is illustrated in FIG. 25B. The electrical component holding section 802 has arm sections 803 that extend from the upper ends or hook ends to elbows 804, arms 806, elbows 808, arms 810, elbows 812, arms 814, elbows 816 and return loop section 815. It will be appreciated portions of component holding section 802 are similar to corresponding portions of component holding section 700 depicted in FIG. 25A. However, according to the present illustrative embodiment, the component holding section 802 depicted in FIG. 25B includes additional arms 814 and elbows 816 which extend from elbow 812s to the return loop section 815. This feature provides more of a closed opening 818 of the component holding section than that depicted in FIG. 25A and provides an even more positive grip on the electrical component(s) being held in the component holding section 802.

In addition, the lengths of the sides forming the electrical component holding section may vary and, for example, may be selected depending among other things, on a size and dimensions of the electrical component(s) the electrical component holding section intended to hold. For example, as depicted in FIG. 25C, sides 823, 820 may be longer than sides 826, 824 such that a substantially vertical rectangular cable holding section 822 is provided. Alternatively, sides 824, 826 may be made longer than sides 823, 820 such that a substantially horizontal rectangular component holding section is provided.

In addition to the number and length of sides forming the component holding section varying, the angles between the various sections forming portions of the component holding section may vary as well. For example, the angles “P”, “P′”, “P′” may vary. That is, one or more of angles “P”, “P′” “P″” may be less than 90 degrees forming a substantially triangular like component holding section. Furthermore, any of the component holding sections described in the present disclosure may be offset. For example, as shown in FIG. 25D, the component holding section 832 may be offset from intermediate arm section 833 at elbow 834. The angle “Q” formed at elbow 834 may generally be between 90-270 degrees and preferably between 135-225 degrees.

In addition, one or more sides forming the component holding section may be non-linear. For example, as depicted in FIG. 25E, component holding section 842 extends from arm sections 843 and includes sides 844, 848, 849 which are substantially straight, while sides 846 may be curved as shown. As shown in FIG. 25E, component holding section 842 may be offset from arm sections 843 at elbows 845 similar to that as described above with respect to FIG. 25D.

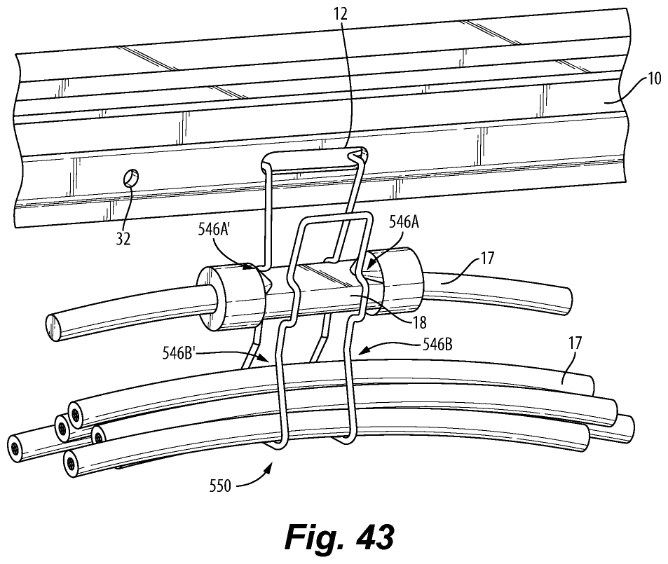

Electrical component hangers according to illustrative embodiments of the present disclosure may be dimensioned and configured to be capable of holding various types of electrical components as well as electrical components having a specific size and shape. For example, as shown in FIG. 25F, component holding section 800 has arm sections 801 that extend from the upper ends or hook ends to elbows 805, 807, arms 809, elbows 811, arms 813, elbows 817, arms 819, elbows 821, elbows 825 and return loop section 827. Component holding section 800 is substantially rectangular and is dimensioned to receive and hold an electrical component 18 such as that depicted in FIG. 43. At least a portion of the electrical component 18 is substantially rectangular in cross-section and may be securely held in component holding section 800. A non-limiting example of such an electrical component is an MC4 connector commonly used in connecting solar panels and which includes a generally rectangular shaped cross-sectional portion.

Any of the component hangers described in the present disclosure may include one or more coatings having particular characteristics suitable for a particular application. For example, FIG. 15 depicts an electrical component hanger 500 according to an illustrative embodiment of the present disclosure which is substantially similar to that described above with respect to FIG. 10. Component hanger 500 includes arms 506, component holding section 508, clip return section 518 and loop section 220. However, according to this illustrative embodiment, a coating 502 is provided on at least the portions of the electrical component hanger 500 that come into contact with an electrical component being inserted into electrical component holding section 508. Depending on a particular application, coating 502 may be an electrical insulator and/or may provide a higher coefficient of friction than the material forming the hanger 500 itself. This allows an electrical component being held in the hanger 500 to be electrically isolated from the hanger 500 and any structure upon which the hanger 500 is mounted. Providing a higher coefficient of friction provides a surer grip to hold an electrical component in position. Examples of suitable coatings may include rubber or rubber like materials, plastics, varnish, etc. Coating 502 may be applied to hanger 500 in any suitable manner including, for example, by brush, spray or dipping, etc.

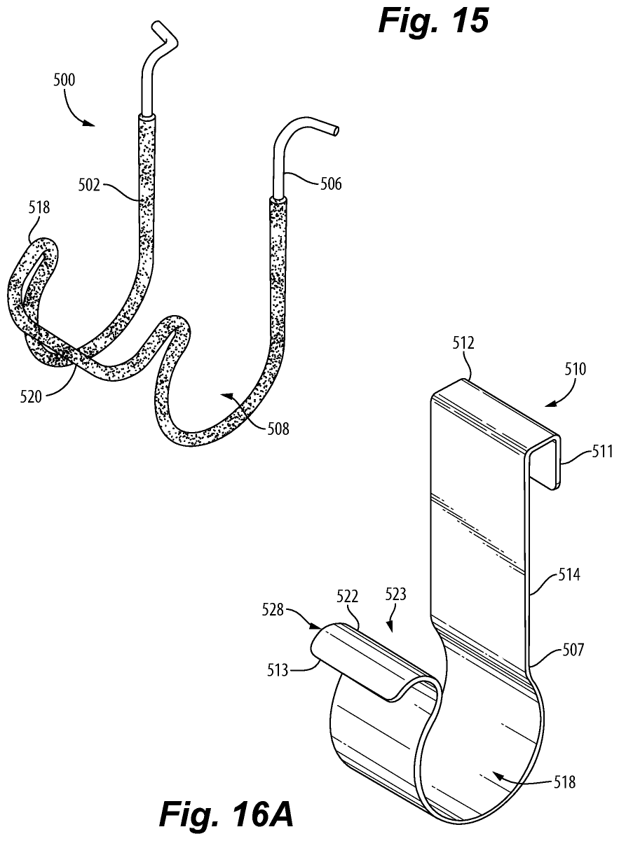

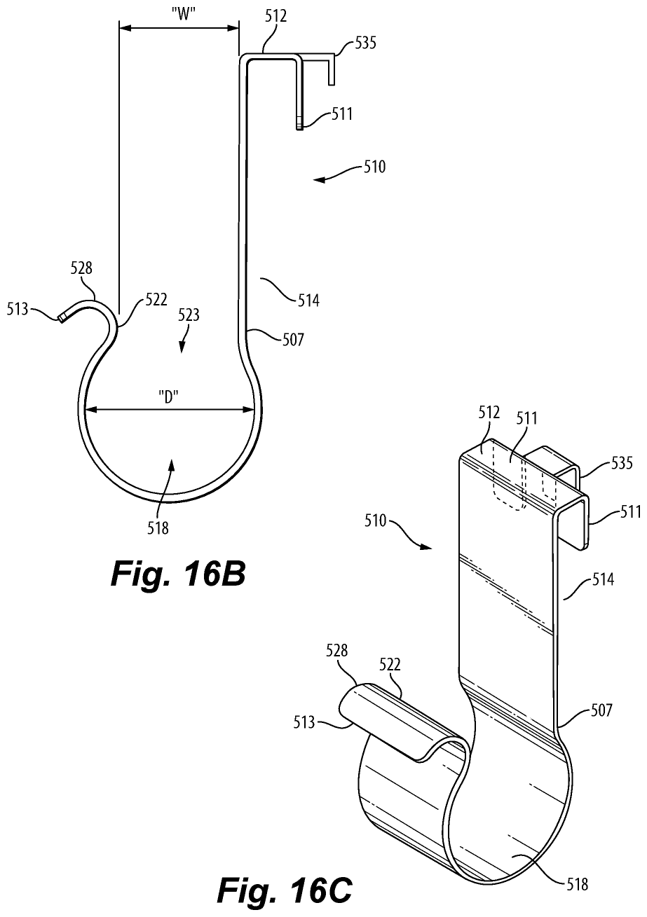

An electrical component hanger according to another illustrative embodiment of the present disclosure is shown in FIGS. 16A-16C. According to this embodiment, the electrical component hanger 510 is formed from a strip or sheet 514 of spring steel (e.g., galvanized or stainless spring steel). Hanger 510 includes a proximate end 511 formed in the shape of a hook 512 capable of being hooked onto a hole in a structure (e.g., see hole 12 in rail 10 FIG. 4). According to an embodiment of the present disclosure as shown in FIGS. 16B, 16C, a secondary hook 535 may be cut or pressed and shaped from proximate end 511 and extend from hook 512. Secondary hook 535 is generally narrower than hook 512 and dimensioned to fit into smaller holes provided in a structure or rail (e.g., see hole 32 in rail 10 FIG. 4). Distal end 513 includes a clip section 528 providing a rounded edge surface 522. An electrical component holding section 518 is substantially circular and has a diameter D and is dimensioned to receive and secure an electrical component such as, for example, a fuse or cable connector. This diameter D may be the same or slightly smaller than the diameter of the electrical component being received providing a snug and secure fit. The rounded edge surface 522 allows an electrical component to be easily slid into place in component holding section 518 and prevents binding on any sharp edges. According to the present illustrative embodiment, at rest the width W of the gap 523 between arm 507 and rounded edge 522 may be smaller than the diameter D of the component holding section 518 and/or the diameter of the electrical component being inserted into component holding section 518. By pressing the electrical component into the gap 523, clip section 528 will move outwardly expanding the gap 523 and then return inwardly when the component is properly seated in component holding section 518.

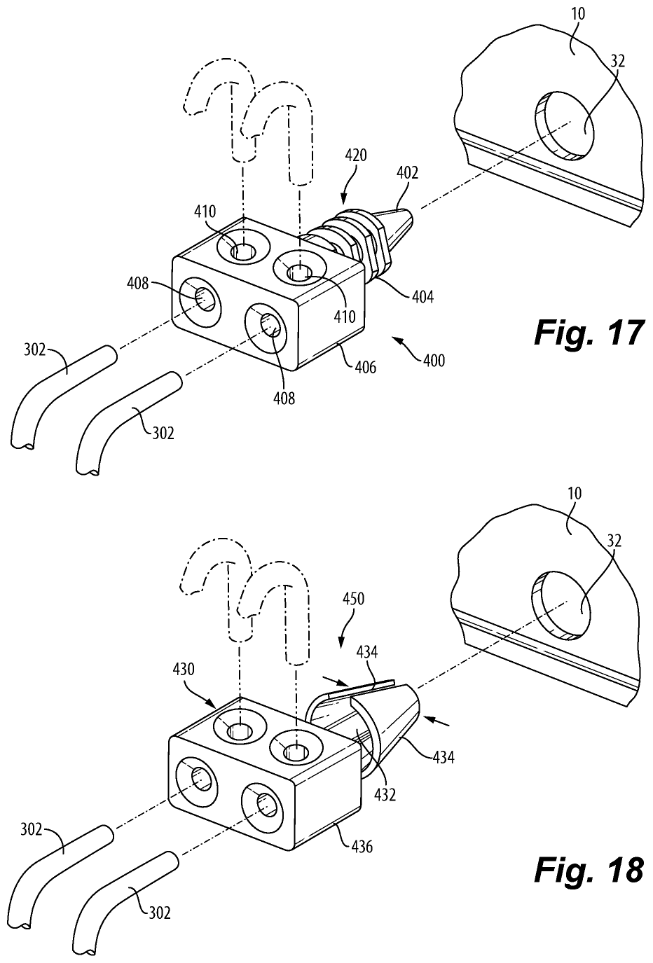

Embodiments of the electrical component hangers as described herein can be mounted directly to support structures as described above. In addition, embodiments of the electrical component hangers can be attached to support structures utilizing intermediate attachments. For example, as shown in FIG. 17, an intermediate attachment or attachment 400 according to an embodiment of the present disclosure has a connection portion 420 which includes a core 402 having a series of flexible ribs 404 extending therefrom which are designed and dimensioned to flex when slid into a hole 32 in a rail 10. After insertion, flexible ribs 404 return to shape thus securing the intermediate attachment 400 to the rail. Connection portion 420 is connected to a receiving block 406 as shown. Receiving block 406 has one or more holes therein for receiving and holding an electrical component holder according to embodiments of the present disclosure. For example, one or more holes 408 and/or one or more holes 410 may be provided. The holes may be tapered from opening to the back of the hole providing a snug secure fit when wires forming the electrical component hanger are inserted. Holes 408 would be appropriate for receiving hook ends 302 of the electrical component hanger depicted in FIG. 12D, for example. Holes 410 would be appropriate for receiving hook ends (102, 202 depicted in FIGS. 1 and 7, respectively) of the electrical component hangers depicted in FIGS. 1-9, for example. FIG. 18 depicts an intermediate attachment 430 according to another exemplary embodiment of the present disclosure. Receiving block 436 is similar to receiving block 406 shown in FIG. 17 but is mounted to a connection portion 450 which includes a core 432 having wings 434 extending therefrom. Wings 434 flex inward when being inserted into hole 32 and expand outward when through the hole 32, thus securing the intermediate attachment 430 to the rail 10. Receiving blocks 406, 436 may include a slotted hole for receiving the hook ends which flare outwardly as described above with respect to FIGS. 12B, 22, etc. Of course, other types of permanent or temporary attachment mechanisms are contemplated for mounting the attachment block 406, 436 to a structure.

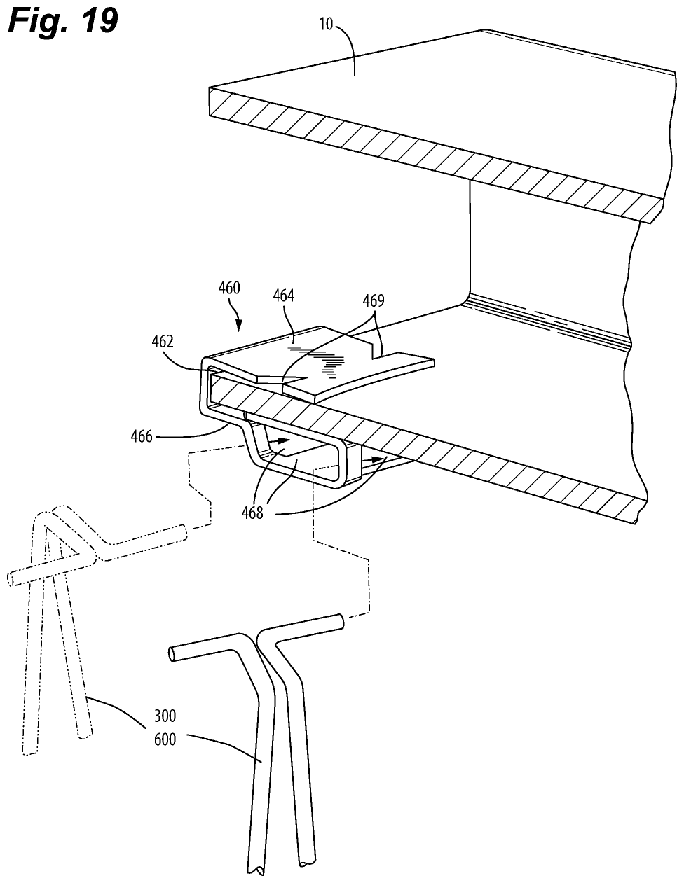

Another type of intermediate attachment is depicted in FIG. 19 and is referred to generally as attachment clip or clip 460. Clip 460 includes a slot 462 having an outer side 464 and an inner side 466. The outer side 464 and/or the inner side 466 may include one or more teeth 469 extending into the slot 462. Clip 460 also includes one or more openings 468. The slot 462 of clip 460 is slipped over a railing or other structure 10 and press fit such that the teeth 469 engage the surface of the railing 10 securing the clip in place. One or more of the electrical component hangers described in the present disclosure may then be mounted to clip 460 using openings 468. In particular, any of the embodiments described herein in which the hook end sections flare outwardly (e.g., see FIGS. 10, 12A, 22, hangers 300, 600) may be particularly well suited for attachment utilizing clip 460.

The described intermediate attachments may be formed from a material capable of assuming a particular shape and substantially retaining that shape. Non-limiting examples of such materials include plastics or plastic like materials, metals such as steel, spring steel, etc. The intermediate attachment, if made from steel, spring steel, etc., may be coated with a suitable material to protect it from the environment. For example, the spring steel may be galvanized. Alternatively, other forms of environmentally protected materials such as stainless spring steel may be utilized to form suitable portions of the intermediate attachments described herein. One or more portions of the material may be provided with a coating which is non-conductive and/or provides a higher coefficient of friction than the material itself. The gauge of the material is selected to be suitable for the shape and/or size of the electrical component to be held by a holder being attached to a rail or frame using the intermediate attachment and generally may range between 6-18 gauge.

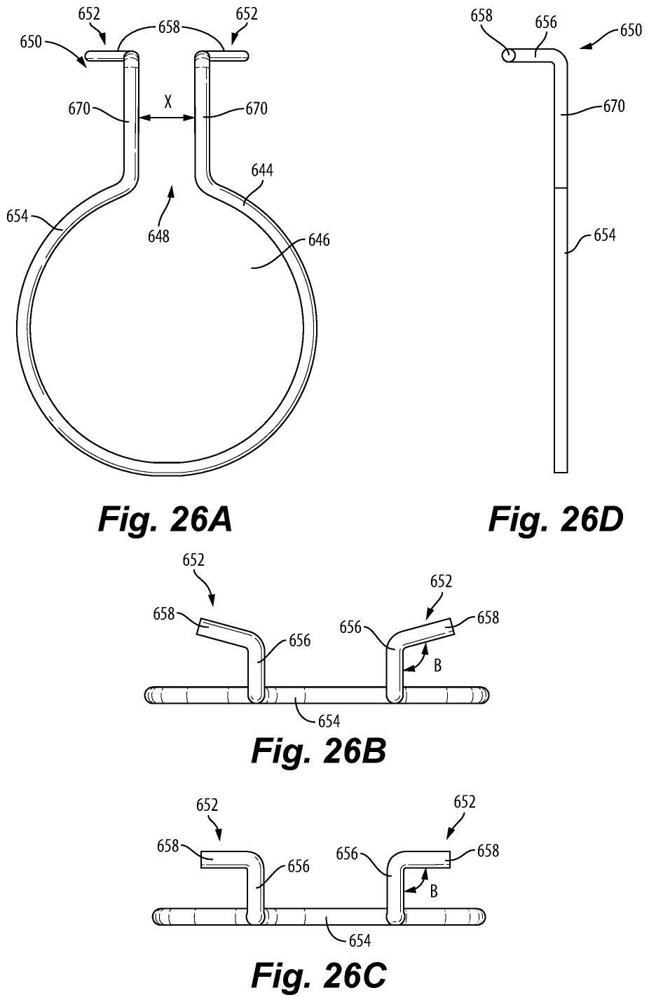

An electrical component hanger according to another illustrative embodiment of the present disclosure is shown in FIG. 26A-26D and is referred to generally as hanger 650. In this exemplary embodiment, the hanger 650 is formed from a segment of wire 644. Wire 644 may have a substantially circular cross section, although other cross-sectional shapes including square, rectangular, octagonal, etc. are also contemplated. According to this illustrative embodiment of the present disclosure, the component holding section 646 is formed generally in the shape of a circular loop 654 having an opening 648. Arms 670 extend from the circular loop 654. According to the present illustrative embodiment, the arms 670 are generally parallel to each other and extend to a point where the wire 644 makes generally right-angle bends to end sections 652. The length of arms 670 may be the same, similar or different from each other as discussed with respect to other illustrative embodiments described herein. In general, the length of arms 670 may be selected depending on a design and dimensions of a frame to which the hanger 650 is to be attached. End sections 652 include extensions 656 which extend perpendicularly to a plane formed by the circular loop 654 and arms 670 as shown in FIG. 26D. Hooks 658 then extend at an angle “B” from extensions 656 as shown. For example, as depicted in FIG. 26B, angle “B” may be greater than 90 degrees and may generally be up to 180 degrees (or more) as similarly depicted in above-described embodiments. As depicted in FIG. 26C, angle “B” may be 90 or less as desired depending on a particular application. The width “X” of the opening 648 may depend on the size of the electrical components to be held by the hanger 650. For example, depending on a particular application, it may be preferable that width “X” be smaller than a width (or diameter or gauge) of the electrical component(s) to be inserted into component holding section 646. Arms 670 are sufficiently flexible so that they can be spread apart as the electrical component(s) are being passed through opening 648. In this way, as the electrical component(s) are being added to the component holding section 646, they are less likely to become dislodged from the hanger 650 prior to and after the hanger 650 is hung on a bracket or frame. The diameter or area of component holding section 646 may vary depending on a number of factors including, for example, the size, shape and number of electrical components to be held. It will be appreciated that hanger 650 may also be suitably dimensioned for holding excess wiring or cabling. That is, any excess wiring or cabling may be coiled or bundled and held by hanger 650 providing a neat and efficient solution for safely managing such cabling. For example, after the excess wiring or cabling has been coiled, one end section 652 of hanger 650 may be passed through the coiled wiring or cabling and the hanger then attached to the nearest attachment point on a bracket or frame.

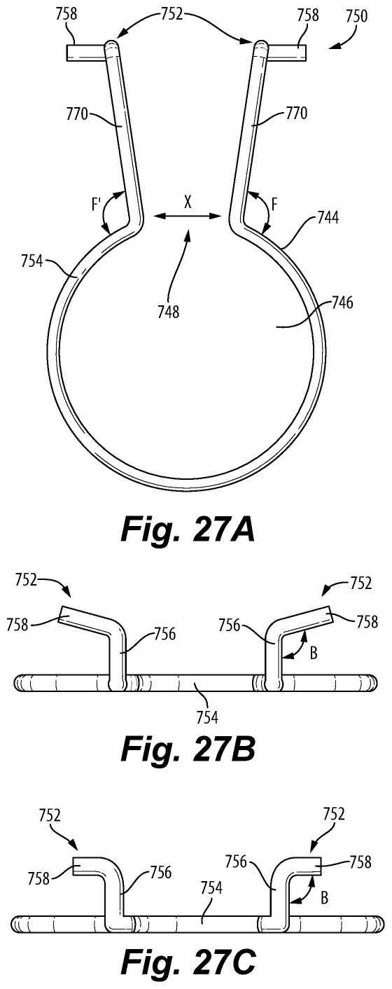

An electrical component hanger according to another illustrative embodiment of the present disclosure is shown in FIG. 27A-27C and is referred to generally as hanger 750. In this exemplary embodiment, the hanger 750 is formed from a segment of wire 744. Wire 744 may have a substantially circular cross section, although other cross-sectional shapes including square, rectangular, octagonal, etc. are also contemplated. According to this illustrative embodiment of the present disclosure, the component holding section 746 is formed generally in the shape of a circular loop 754 having an opening 748. Arms 770 extend from the circular loop 754. According to the present illustrative embodiment, the arms 770 are not parallel and instead flair outwards at angles “F”, “F′” as shown in FIG. 27A. Angles “F” and “F′” may generally be between 45-180 degrees and may be the same or different from each other. Arms 770 each extend to a point where the wire 744 makes a generally right-angle bend to end sections 752. The length of arms 770 may be the same, similar or different from each other as discussed with respect to other illustrative embodiments described herein. In general, the length of arms 770 may be selected depending on a design and dimensions of a frame to which the hanger 750 is to be attached. End sections 752 may or may not include extensions 756 which extend generally perpendicular to a plane formed by the circular loop 754 and arms 770. Hooks 758 then extend at an angle B from extensions 756 as shown. As depicted in FIG. 27B, angle B may be greater than 90 degrees and may generally be up to 180 degrees (or more) as described in the above-embodiments. As depicted in FIG. 27C, angle B may be 90 or less as desired depending on a particular application. The width “X” of the opening 748 at its narrowest point may depend on the size of the electrical components to be held by the hanger 750. For example, depending on a particular application, it may be preferable that width “X” be smaller than a width (or diameter or gauge) of the electrical component(s) to be inserted into component holding section 746. Arms 770 are sufficiently flexible so that they can be spread apart as the electrical component(s) are being passed through opening 748. In this way, as the electrical component(s) are being added to the component holding section 746, they are less likely to become dislodged from the component holding section 746 prior to and after the hanger 750 is hung on a bracket or frame. The diameter or area of component holding section 746 may vary depending on a number of factors including, for example, the size, shape and number of electrical components to be held. It will be appreciated that hanger 750 may also be suitable for holding excess wiring or cabling. That is, any excess wiring or cabling may be coiled or bundled and held by hanger 750 providing a neat and efficient solution for safely managing such cabling. For example, after the excess wiring or cabling has been coiled, one end section 752 of hanger 750 may be passed through the coiled wiring or cabling and the hanger then attached to the nearest attachment point on a bracket or frame.

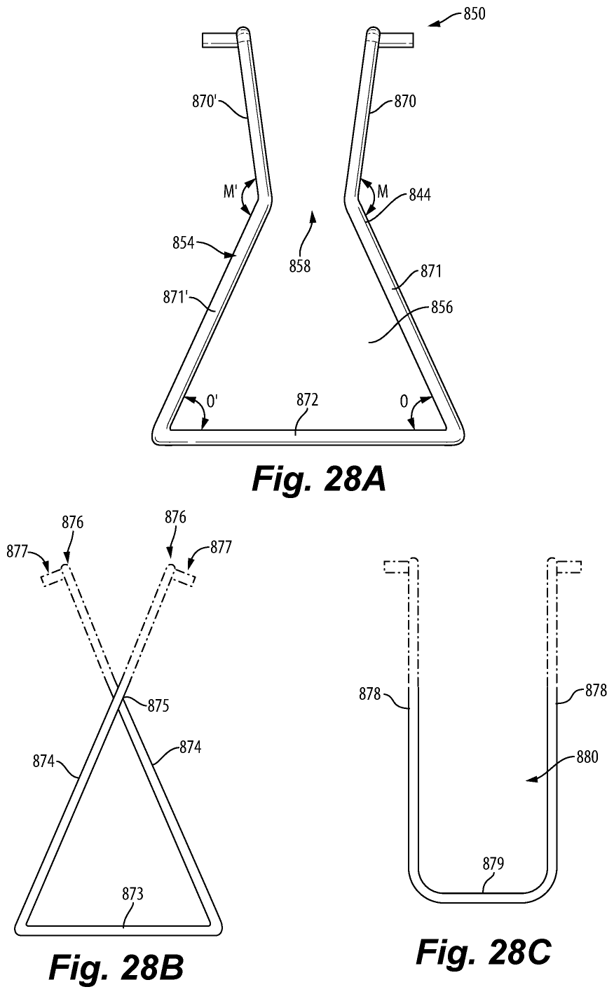

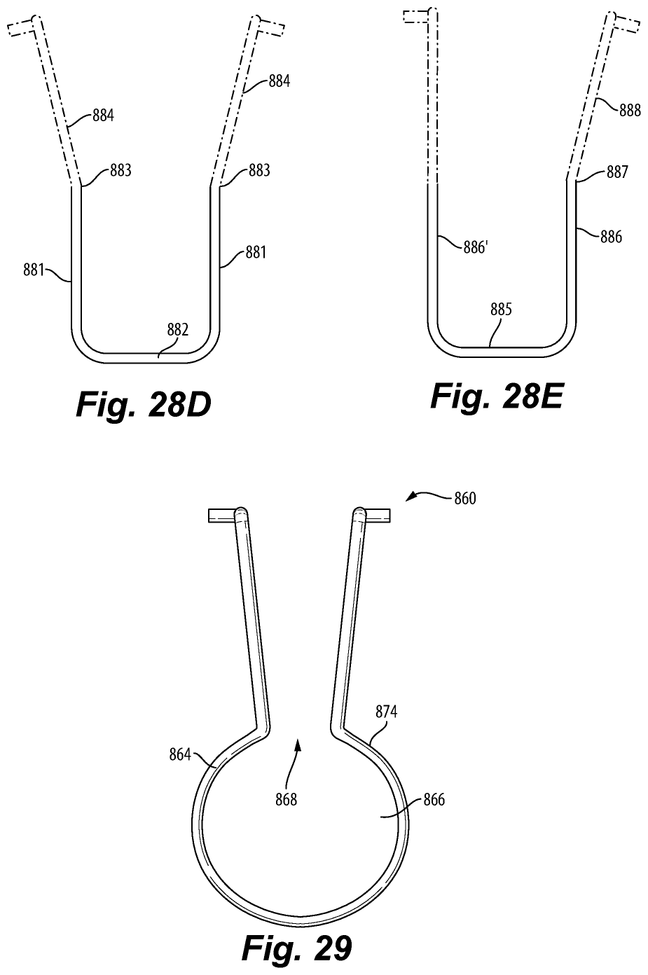

The component holding sections of electrical component hangers as described herein may be other than round. For example, the component holding sections depicted herein may be generally polygonal in shape having any suitable number of sides and may include one or more nonlinear or curved sides. For example, an electrical component hanger according to another illustrative embodiment of the present disclosure is shown in FIG. 28A and is referred to generally as hanger 850. In this exemplary embodiment, the hanger 850 is formed from a segment of wire 844 and has a substantially triangular shaped loop 854 forming component holding section 856 having an opening 858. Arms 871, 871′ extend from cross arm 872 at angles “O” “O′” and may be the same or different from each other and may generally be less than 90 degrees and greater than 45 degrees. Arms 870 extend from arms 871 at angle “M”, “M′” and may be the same or different from each other and may generally be greater than 90 degrees and less than 270 degrees. The remaining portions of hanger 850 may be similar to those described herein with respect to other embodiments and for reasons of brevity will not be described in further detail.

According to an illustrative embodiment of the present disclosure as depicted in FIG. 28B, arms 874 may extend from arm 873 at angles and are sufficiently long such that arms 874 cross at point 875 and further extend to end sections 876. Hook ends 877 extend outwardly from end sections 876 as shown. As depicted in 28C, arms 878 may extend straight upward from cross arm 879 forming a substantially square or rectangular component holding section 880. According to another embodiment of the present disclosure depicted in FIG. 28D, arms 881 extend from cross arm 882 and are substantially parallel up to elbows 883 and flare out to arms 884. According to other illustrative embodiments of the present disclosure, the vertical arms are not necessarily the same or complementary. For example, as depicted in FIG. 28E, arms 886, 886′ extend from cross arm 885. However, according to this illustrative embodiment, arm 886 bends at elbow 887 to arm 888. Such a dissimilar arm configuration might be particularly suitable for situations where the hanger needs to be fit into and be attached to a structure having tight or other odd configuration.

An electrical component hanger according to another illustrative embodiment of the present disclosure is shown in FIG. 29 and is referred to generally as hanger 860. According to this illustrative embodiment of the present disclosure, the component holding section 866 is formed generally in the shape of an oblong loop 864 having an opening 868. The remaining portions of hanger 860 are similar to those described above with respect to FIGS. 26, 27 and for reasons of brevity will not be described in further detail.

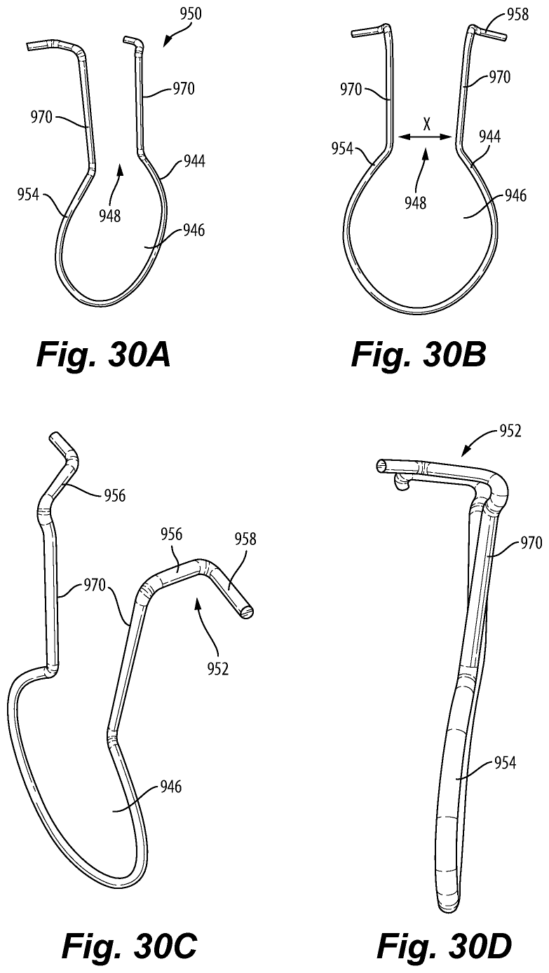

An electrical component hanger according to another illustrative embodiment of the present disclosure is shown in FIGS. 30A-30D and is referred to herein as hanger 950. In this exemplary embodiment, the hanger 950 is formed from a segment of wire 944. Wire 944 may have a substantially circular cross-section, although other cross-sectional shapes including square, rectangular, octagonal, etc. are also contemplated. According to this illustrative embodiment of the present disclosure, the component holding section 946 is formed generally in the shape of a circular loop 954 having an opening 948. Arms 970 extend from the circular loop 954. According to the present illustrative embodiment, the arms 970 flair outwards as shown best in FIG. 30B. Arms 970 each extend to a point where the wire 944 makes a generally right angle bend to end sections 952 (e.g., see FIG. 30C). The length of arms 970 may be the same, similar or different from each other as described in the above-described embodiments. In general, the length of arms 970 may be selected depending on a design and dimensions of a frame to which the hanger 950 is to be attached as well as the size and number of electrical components to be held. End sections 952 include extensions 956 which extend perpendicularly to a plane formed by the circular loop 954 and arms 970 (e.g., see FIG. 30D). Hooks 958 then extend at an angle from extensions 956 as shown. As described in above embodiments, this angle may be greater than 90 degrees and may be up to 180 degrees or more as described above. As depicted in FIG. 30C, this angle may be approximately 90 (or less) as desired depending on a particular application. The width “X” of the opening 948 at its narrowest point may depend on the size of the electrical components to be held by the hanger 950. For example, depending on a particular application, it may be preferable that width “X” be smaller than a width (or diameter or gauge) of the electrical component(s) to be inserted into component holding section 946. Arms 970 are sufficiently flexible so that they can be spread apart as the electrical component(s) are being passed through opening 948. In this way, as the electrical component(s) are being added to the component holding section 946, they are less likely to become dislodged from the component holding section 946 prior to the hanger 950 being hung on a bracket or frame. The diameter or area of component holding section 946 may vary depending on a number of factors including, for example, the size, shape and number of electrical components to be held. It will be appreciated that hanger 950 may be particularly suitable for holding excess wiring or cabling. That is, any excess wiring or cabling may be coiled or bundled and held by hanger 950 providing a neat and efficient solution for safely managing such cabling. For example, after the excess wiring or cabling has been coiled, one end section 952 of hanger 950 may be passed through the coiled wiring or cabling and the hanger then attached to the nearest attachment point on a bracket or frame.

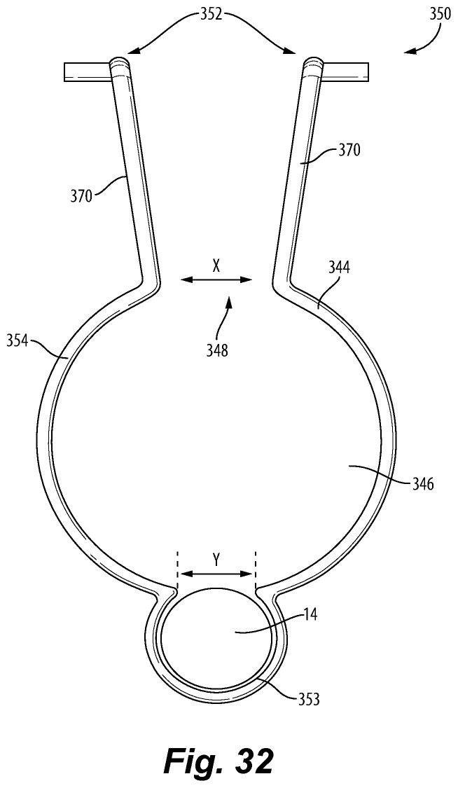

An electrical component hanger according to another illustrative embodiment of the present disclosure is shown in FIG. 32 and is referred to herein as hanger 350. In this exemplary embodiment, hanger 350 is formed from a segment of wire 344. Wire 344 may have a substantially circular cross-section, although other cross-sectional shapes including square, rectangular, octagonal, etc. are also contemplated. According to this illustrative embodiment of the present disclosure, the component holding section 346 is formed generally in the shape of a circular loop 354 having an opening 348. Arms 370 extend from the circular loop 354. According to the present illustrative embodiment, the arms 370 flair outwards. Arms 370 each extend to a point where the wire 344 makes a generally right angle bend (similar to the embodiments described and shown in FIGS. 26-31) to end sections 352. The length of arms 370 may be the same, similar or different from each other as described in the above-described embodiments. In general, the length of arms 370 may be selected depending on a design and dimensions of a frame to which the hanger 350 is to be attached as well as the size and number of electrical components to be held. The width “X” of the opening 348 at its narrowest point may depend on the size of the electrical components to be held by the hanger 350. For example, depending on a particular application, it may be preferable that width “X” be smaller than a width (or diameter or gauge) of the electrical component(s) to be inserted into component holding section 346. Arms 370 are sufficiently flexible so that they can be spread apart as the electrical component(s) are being passed through opening 348. In this way, as the electrical component(s) are being added to the component holding section 346, they are less likely to become dislodged from the component holding section 346 prior to the hanger 350 being hung on a bracket or frame. The diameter or area of component holding section 346 may vary depending on a number of factors including, for example, the size, shape and number of electrical components to be held. It will be appreciated that hanger 350 may also be suitable for holding excess wiring or cabling. That is, any excess wiring or cabling may be coiled or bundled and held by hanger 350 providing a neat and efficient solution for safely managing such cabling. For example, after the excess wiring or cabling has been coiled, one end section 352 of hanger 350 may be passed through the coiled wiring or cabling and the hanger then attached to the nearest attachment point on a bracket or frame. According to this illustrative embodiment, circular loop 354 includes one or more secondary loops 353 dimensioned and shaped to receive one or more electrical component(s) 14. For example, for an electrical component such as a fuse or cable connector, secondary loop 353 may have a diameter approximately the same or slightly smaller than a diameter of the fuse or cable connector 14. The width “Y” of the opening to secondary loop 353 may be slightly smaller than the diameter of the fuse or cable connector 14 such that the fuse or cable connector 14 may be “snapped” into the secondary loop 353 and held in position by force of the spring wire 344. Any excess cabling or wiring attached to fuse or cable connector 14 may then be coiled and held in loop 354 as described above.

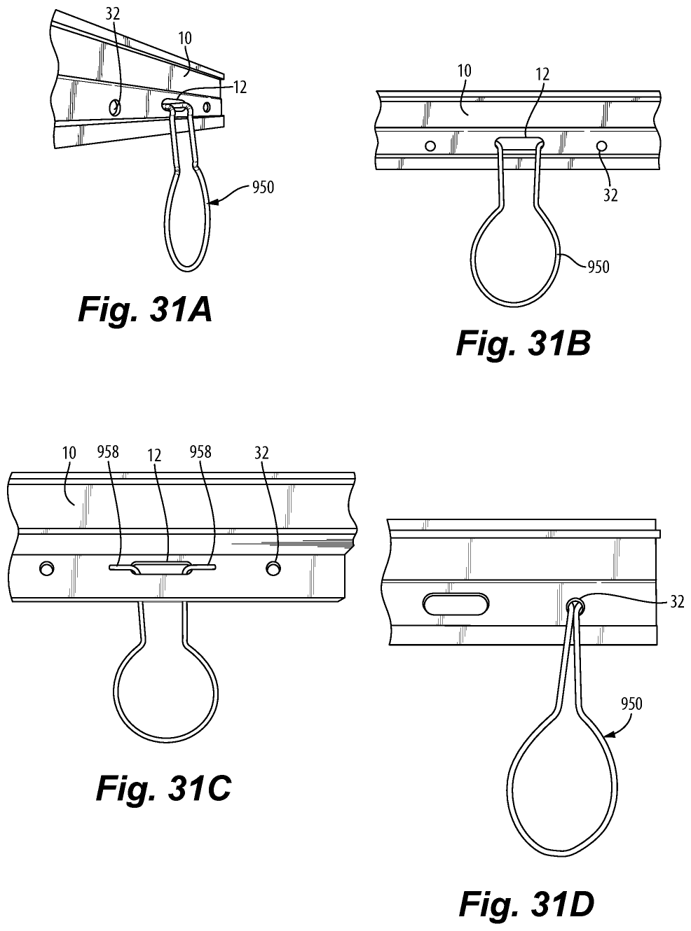

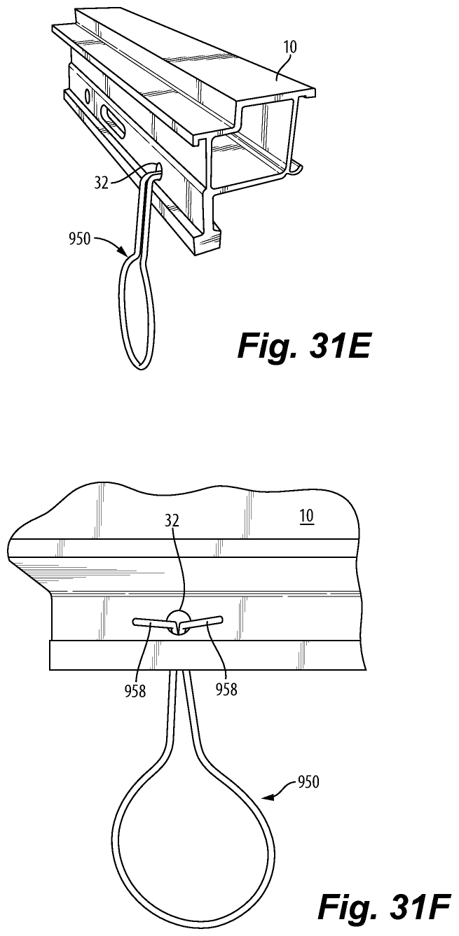

Embodiments of the electrical component hangers depicted in FIGS. 26-30 and 32 are particularly well suited for managing electrical components extending in various directions with respect to the frame or bracket to which the components are to be attached. For example, since the hooks extend perpendicular to the component holding sections, these component hangers are particularly well suited for managing electrical components that extend in a direction intersecting a particular portion of a frame or bracket (see FIGS. 31A-31F). In addition, because the end sections 952 of the hanger 950 are capable of being pressed together and will return to their original position because of the spring action of the spring steel forming wire 944, hanger 950 can be hung from a frame or bracket 10 having various types of attachment points. For example, according to the embodiments depicted in FIGS. 31A-31F, the hanger 950 can be hung from a frame or bracket having relatively small round (or other shaped) holes 32 and/or relatively large slotted holes 12. As illustrated in FIG. 31C, any of the component hangers described herein may be hung directly under a horizontally extending frame or bracket having one or more holes 12 or 32 positioned on a bottom face of the frame or bracket.

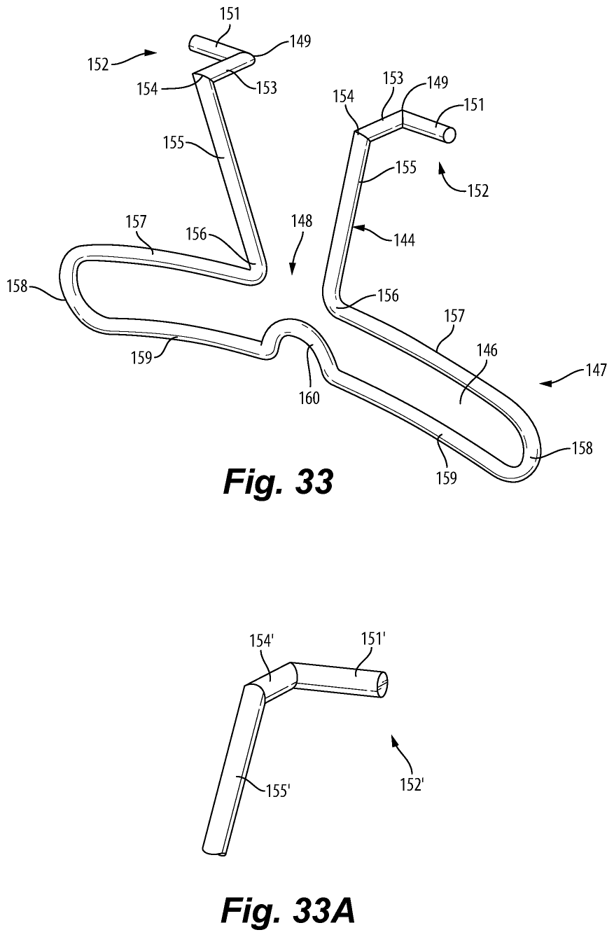

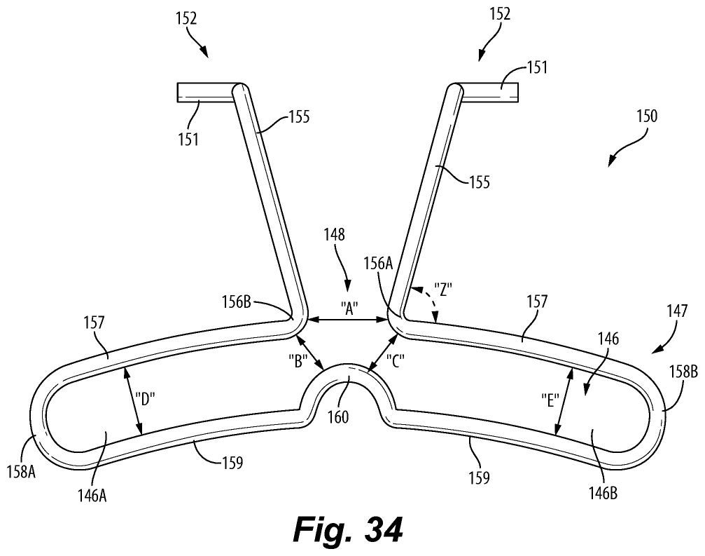

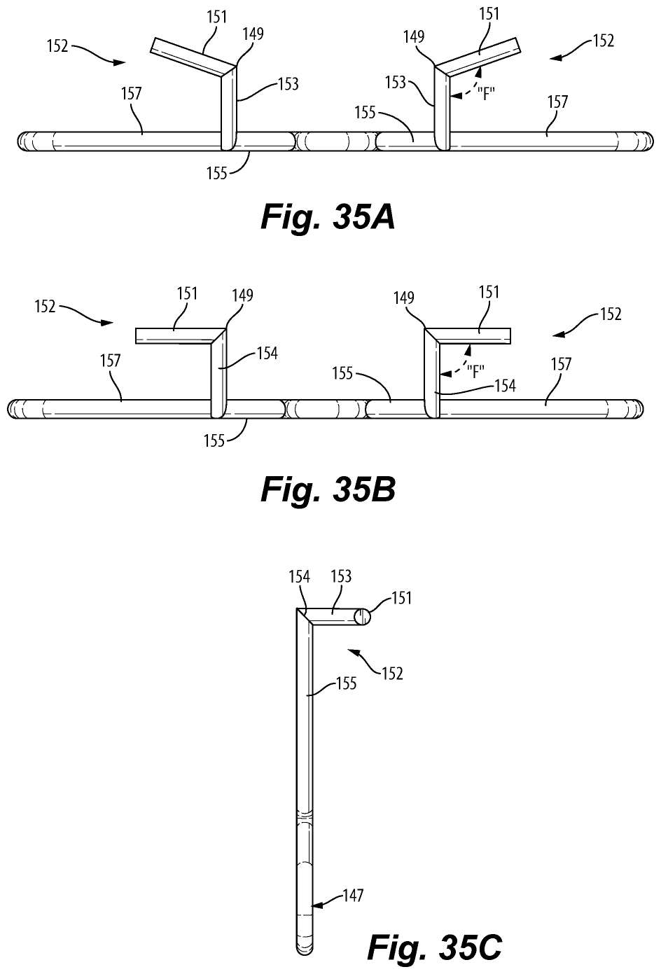

An electrical component hanger according to other illustrative embodiments of the present disclosure is shown in FIGS. 33-36 and is referred to generally as hanger 150. Hanger 150 is formed from a segment of wire 144. Wire 144 may have a substantially circular cross section, although other cross-sectional shapes including square, rectangular, octagonal, etc. are also contemplated. According to this illustrative embodiment of the present disclosure, the component holding section 146 is formed generally in the shape of an oblong or rectangular-like loop 147 formed by upper arms 157, C shaped ends 158, lower arms 159 and middle projection or arced portion 160. Arms 155 extend from the upper arms 157 at elbows 156. According to the present illustrative embodiment, the arms 155 are not parallel and flair outwards as shown in FIG. 34 forming an angle “Z” between upper arms 157 and arms 155. Angle “Z” is generally less than 90 degrees and may generally be between 60 degrees and 90 degrees, although angles more than 90 degrees may be utilized. Arms 155 each extend to a point where the wire 144 makes a generally right-angle bend at elbows 154 to end sections 152 (e.g., see FIG. 33). The length of arms 155 may be the same, similar or different from each other as described in the above-described embodiments. In general, the length of arms 155 may be selected depending on a design and dimensions of a frame to which the hanger 150 is to be attached. End sections 152 include arms 153 which extend from arms 155 at elbows 154. Arms 153 extend to elbows 149. Hooks 151 then extend from elbows 149 forming an angle “F” between arms 153 and hooks 151. Angle “F” as depicted in FIG. 35A may be greater than 90 degrees and may generally be up to about 180 degrees (or more) as described in the above-embodiments. As depicted in FIG. 35B, angle “F” may be 90 degrees (or less), dependent on a particular application. Arms 153 extend generally perpendicular to a plane formed by the rectangular-like loop 147 and arms 155, as shown in FIG. 35C. The length of arms 153 may vary depending on the configuration of the frame to which the hanger is to be attached. End sections 152′ according to another illustrative embodiment of the present are shown in FIG. 33A. According to this embodiment (as well as any of the other embodiments depicted herein), hook ends 151′ may extend outward directly from arms 155′ (via elbows 154′) eliminating arms 153 and elbows 149. Such an arrangement would be particularly suitable for hanging hanger 150 from a horizontal frame or rail having connection points (e.g., holes 12, 32) on the underside as depicted in FIG. 31C.

Referring to FIG. 34, the width “A” of the opening 148 to component holding section 146 at its narrowest point may depend on the size of the electrical components to be held by the hanger 150. For example, depending on a particular application, it may be preferable that width “A” be smaller than a width (or diameter or gauge) of the electrical component(s) to be inserted into component holding section 146. Arms 155 are sufficiently flexible so that they can be spread apart as the electrical component(s) are being passed through opening 148. Middle projection 160 extends into component holding section 146 and separates the component holding section into two sides 146A and 146B. Separating the component holding section into two sides, limits the distance the electrical components being held in each of the two sides 146A, 146B of component holding section 146 can move or slide within the component holding section 146. Limiting the movement within the component holding sections 146A, 146B minimizes frictional wear on the electrical components being held in the component holding sections. The width “B” between middle projection 160 and elbow 156B may be smaller than a width (or diameter or gauge) of the electrical component(s) to be inserted into component holding section 146. The width “C” between middle projection 160 and elbow 156A may also be smaller than a width (or diameter or gauge) of the electrical component(s) to be inserted into component holding section 146. The width “D” of component holding section 146A may be generally larger than a width (or diameter or gauge) of the electrical component(s) to be inserted into component holding section 146A. The width “E” of component holding section 146B may be larger than a width (or diameter or gauge) of the electrical component(s) to be inserted into component holding section 146B. While the widths “D” and “E” of component holding sections 146A and 146B, respectively, are depicted as being substantially the same, the widths “D” and “E” may be different such that component holding section 146A is capable of holding one or more electrical components having a first width (or diameter or gauge) and the component holding section 146B is capable of holding one or more electrical components having a second width (or diameter or gauge) different than the first width. In this case, the width “B” between middle projection 160 and elbow 156B may be different than the width “C” between middle projection 160 and elbow 156A to accommodate the size of the electrical components being received in component holding sections 146A, 146B. According to an embodiment of the present disclosure, width “B” is selected to be smaller than a width (or diameter or gauge) of the electrical component(s) to be inserted into component holding section 146A and width “C” is selected to be smaller than a width (or diameter or gauge) of the electrical component(s) to be inserted into component holding section 146B. In this way, once the electrical component(s) are inserted into component holding sections 146A, 146B, the components will remain in position within the component holding sections 146A, 146B. As shown in FIG. 34, the shape of the oblong or rectangular-like loop 147 forming component holding sections 146A, 146B include an arc or slant toward C-shaped ends 158A, 158B, respectively. The arc allows electrical components being inserted into component holding sections 146A and 146B to move and settle in the directions of the C-shaped ends 158A and 158B, respectively, and further limits movement of the cables within the component holding sections 146A, 146B.

It will be appreciated that hanger 150 may also be suitable for holding excess wiring or cabling. That is, any excess wiring or cabling may be coiled or bundled and held by hanger 150 providing a neat and efficient solution for safely managing such cabling. For example, after the excess wiring or cabling has been coiled, one of end sections 152 of hanger 150 may be passed through the coiled wiring or cabling and the hanger then attached to the nearest attachment point on a bracket or frame.

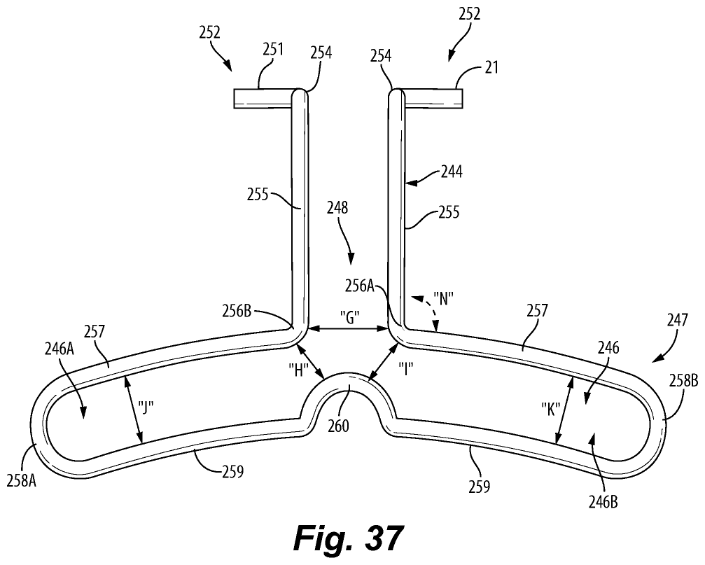

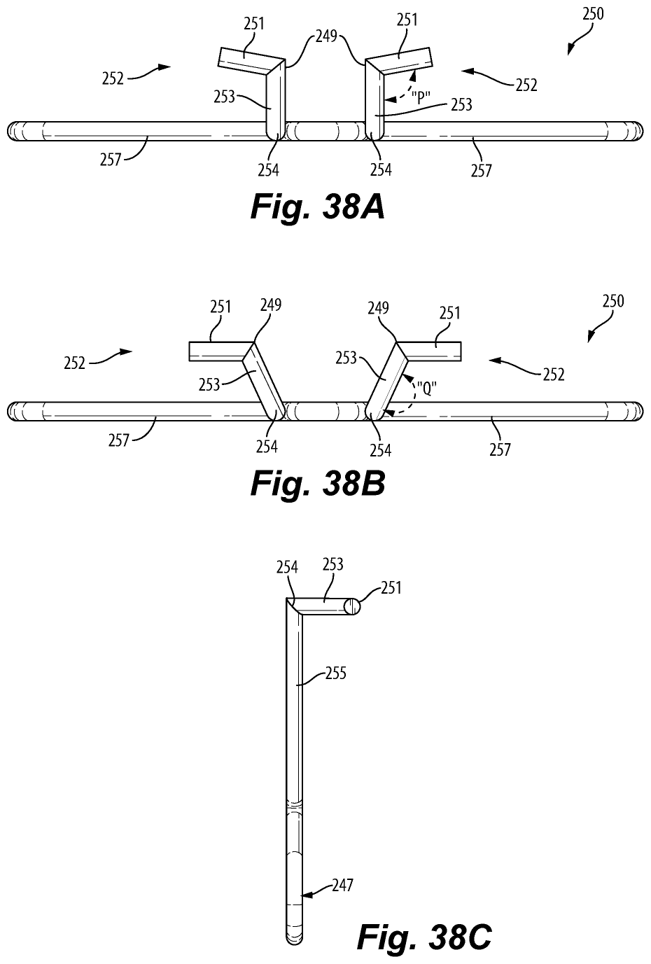

An electrical component hanger according to another illustrative embodiment of the present disclosure is shown in FIGS. 37-39 and is referred to generally as hanger 250. In this exemplary embodiment, the hanger 250 is formed from a segment of wire 244. Wire 244 may have a substantially circular cross section, although other cross-sectional shapes including square, rectangular, octagonal, etc. are also contemplated. According to this illustrative embodiment of the present disclosure, the component holding section 246 is formed generally in the shape of a oblong or rectangular-like loop 247 formed by upper arms 257, C shaped ends 258, lower arms 259 and middle projection or arced portion 260. Loop 247 may be similar to loop 147 described with respect to the embodiments depicted in FIGS. 33-36. Arms 255 extend from the upper arms 257 at elbows 256. According to the present illustrative embodiment, the arms 255 are parallel and flair upwards as shown in FIG. 37 forming an angle “N” between upper arms 257 and arms 255. Angle “N” is generally greater than 90 degrees and may generally be between 90 degrees and 120 degrees. Arms 255 each extend to a point where the wire 244 makes a generally right-angle bend at elbows 254 to end sections 252. The length of arms 255 may be the same, similar or different from each other as described in the above-described embodiments. In general, the length of arms 255 may be selected depending on a design and dimensions of a frame to which the hanger 250 is to be attached. End sections 252 include arms 253 which extend from arms 255 at elbows 254. Arms 253 extend to elbows 249. Hooks 251 then extend at an angle “P” at elbows 249 as shown in FIG. 38A. Angle “P” as depicted in FIG. 38A may be greater than 90 degrees and may generally be up to about 180 degrees (or more) as described in the above embodiments. As depicted in FIG. 38B, arms 253 may extend at an angle “Q” at elbow 254 and may be 90 degrees or less, dependent on a particular application. As depicted in FIG. 38C, arms 253 extend generally perpendicular to a plane formed by the rectangular-like loop 247 and arms 255. The length of arms 253 may vary depending on the configuration of the frame to which the hanger is to be attached. According to another embodiment of the present disclosure, hook ends 251 may extend outward directly from arms 255 eliminating arms 253 and elbows 249, similar to that described above with respect to FIG. 33A. Such an arrangement would be particularly suitable for hanging hanger 250 from a horizontal frame or rail having connection points (e.g., holes 12, 32) on the underside.

Referring to FIG. 37, the width “G” of the opening 248 to component holding section 246 at its narrowest point may depend on the size of the electrical components to be held by the hanger 250. For example, depending on a particular application, it may be preferable that width “G” be smaller than a width (or diameter or gauge) of the electrical component(s) to be inserted into component holding section 246. Arms 255 are sufficiently flexible so that they can be spread apart as the electrical component(s) are being passed through opening 248. Middle projection 260 extends into component holding section 246 and separates the component holding section into two sides 246A and 146B, limiting the distance the electrical components being held in each of the two sides 246A, 246B of component holding section 246 can move or slide within the component holding section 246. Limiting the movement within the component holding section 246 minimizes frictional wear on the electrical components being held in the component holding section 246. The width “H” between middle projection 260 and elbow 256B may be smaller than a width (or diameter or gauge) of the electrical component(s) to be inserted into component holding section 246. The width “I” between middle projection 260 and elbow 256A may also be smaller than a width (or diameter or gauge) of the electrical component(s) to be inserted into component holding section 246. The width “J” of component holding section 246A may be slightly larger than a width (or diameter or gauge) of the electrical component(s) to be inserted into component holding section 246A. The width “K” of component holding section 246B may be slightly larger than a width (or diameter or gauge) of the electrical component(s) to be inserted into component holding section 246B. While the widths “J” and “K” of component holding sections 246A and 246B, respectively, are depicted as being substantially the same, the widths “J” and “K” may be different such that component holding section 246A is capable of holding one or more electrical components having a first width (or diameter or gauge) and the component holding section 246B is capable of holding one or more electrical components having a second width (or diameter or gauge) different than the first width. In this case, the width “H” between middle projection 260 and elbow 256B may be different than the width “2” between middle projection 260 and elbow 256A to accommodate the size of the electrical components being received in component holding sections 246A, 246B. According to an embodiment of the present disclosure, width “H” is selected to be smaller than a width (or diameter or gauge) of the electrical component(s) to be inserted into component holding section 246A and width “I” is selected to be smaller than a width (or diameter or gauge) of the electrical component(s) to be inserted into component holding section 246B. In this way, once the electrical component(s) are inserted into component holding sections 246A, 246B, the components will remain in position within the component holding sections 246A, 246B. As shown in FIG. 34, the shape of the oblong or rectangular-like loop 247 forming component holding sections 246A, 246B include an arc or slant toward C-shaped ends 258A, 258B, respectively. The arc allows electrical components being inserted into component holding sections 246A and 246B to move and settle in the directions of the C-shaped ends 258A and 258B, respectively, and further limits movement of the cables within the component holding sections 246A, 246B.

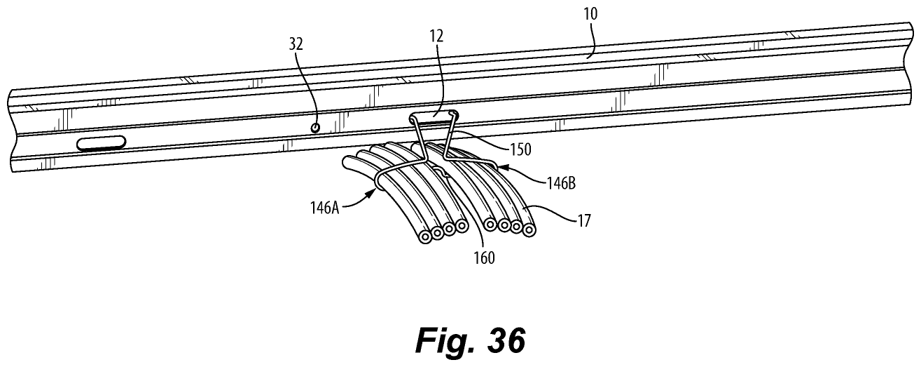

Hangers 150, 250 may be hung from any of the various types of connection points generally found in a rail such as rail 10 depicted in FIG. 36. For example, as described in the present disclosure, hangers 150, 250 may be connected via round holes 32 and oval or slotted holes 12. As shown, a plurality of cables 17 (in this example, eight cables) are efficiently and neatly held by the hanger 150. As shown, four cables are held in each of the side portions 146A, 146B of hanger 150 and separated by middle projection or arced portion 160, leaving minimal room for movement of the components within the hanger 150, preventing chafing or damage to the components. Furthermore, since the components are held in a single row and are not in any type of stacked arrangement, possible damage from stacking of the components is even less likely.

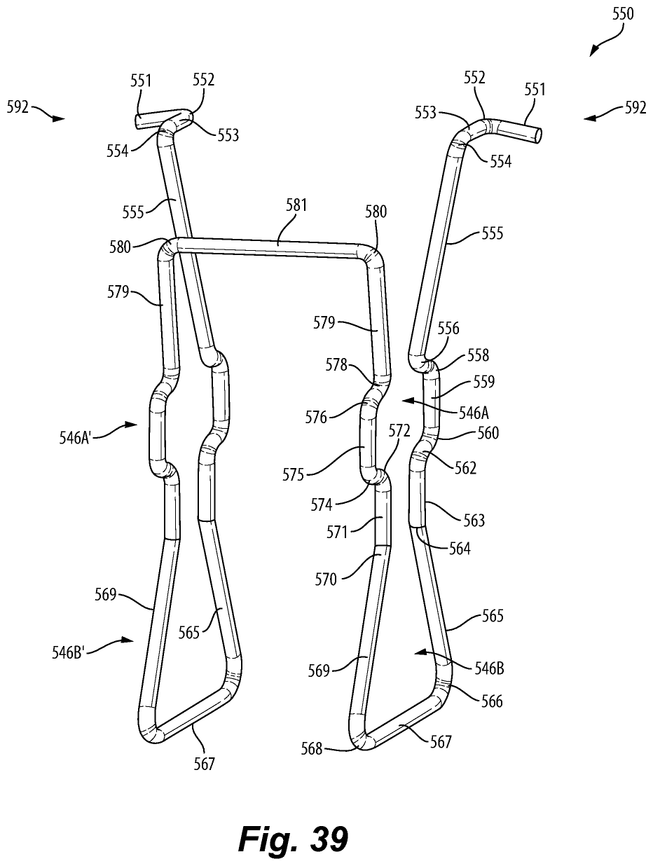

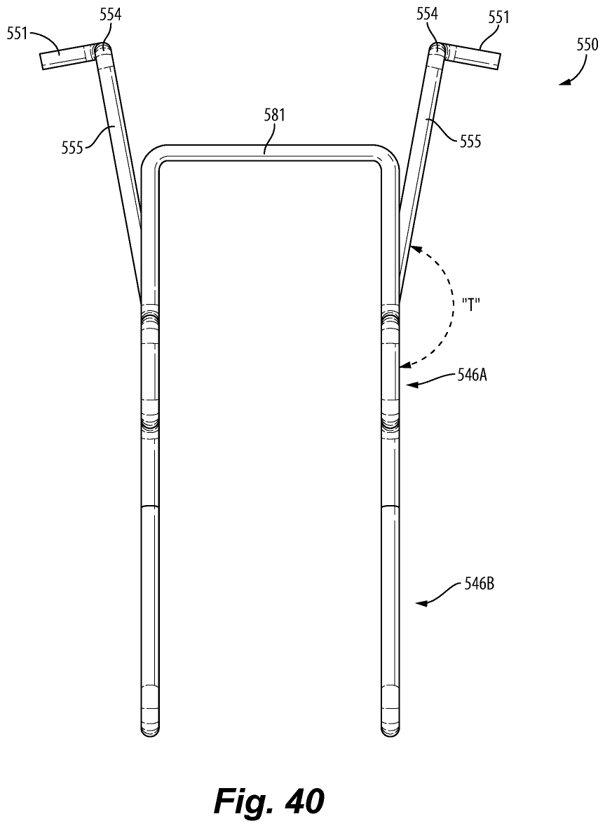

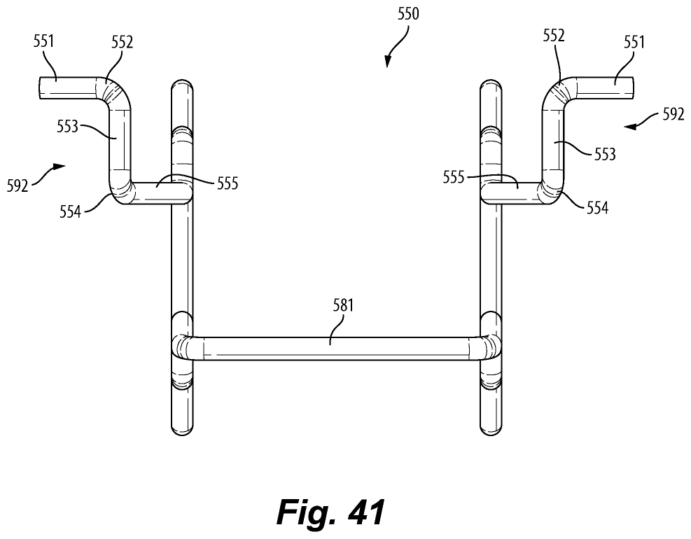

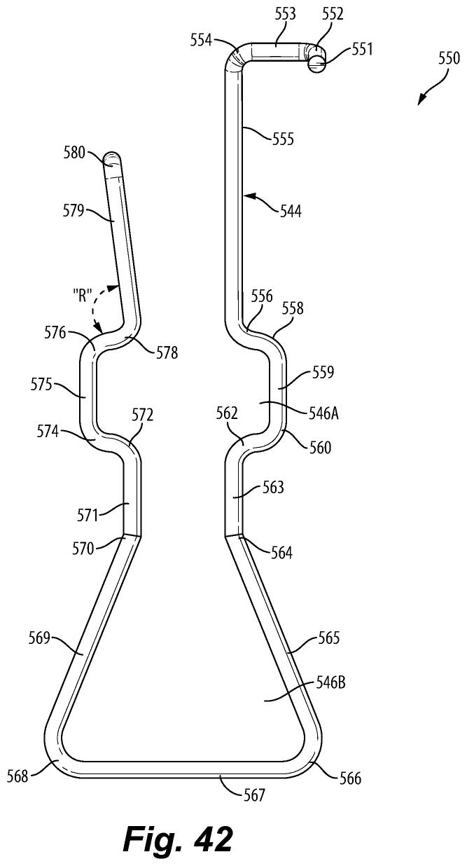

An electrical component hanger according to another illustrative embodiment of the present disclosure is shown in FIGS. 39-43 and is referred to generally as hanger 550. In this exemplary embodiment, the hanger 550 is formed from a segment of wire 544. Wire 544 may have a substantially circular cross section, although other cross-sectional shapes including square, rectangular, octagonal, etc. are also contemplated. According to this illustrative embodiment of the present disclosure, hanger 550 has two pairs of component holding sections including first or upper component holding sections 546A, 546A′ and second or lower component holding sections 546B, 546B′. Component holding sections 546B, 546B′ may be used to hold one or more electrical components such as wiring and cabling while component holding sections 546A, 546A′ may be used to hold one or more electrical components such as electrical fuses, cable connectors, etc. The second or lower component holding sections 546B, 546B′ are substantially similar and are formed generally by lower base portions 567 which extend upward at elbows 566, 568 to arms 565, 569, respectively. As depicted in FIG. 42, these portions of hanger 550 form generally triangular second or lower component holding sections 546B, 546B′. Although lower component holding sections 546B, 546B′ are shown as mirror images of each other, it will be appreciated the lower component holding sections 546B, 546B′ may be shaped differently from each other. For example, according to other embodiments, one and/or the other of the lower component holding sections 546B, 546B′ may be in the shape of a circle, square, oblong, rectangle, etc., similar to other embodiments described herein. Arms 565, 569 then extend upward at elbows 564, 570 to arms 563, 571, respectively. Arms 563, 571 then extend to elbows 562, 560 and 572, 574, respectively, to arms 559, 575. Arms 559, 575 then extend to elbows 558, 556 and 576, 578, respectively. The first or upper component holding sections 546A, 546A′ form a generally rectangular shape as shown in FIG. 42. Although upper component holding sections 546A, 546A′ are shown as mirror images of each other, it will be appreciated the upper component holding sections 546A, 546A′ may be shaped differently from each other and may depend, for example, on the shape and size of the electrical component(s) intended to be held in component holding sections 546A, 546A′. For example, according to other embodiments, one and/or the other of the upper component holding sections 546A, 546A′ may be in the shape of a circle, square, oblong, etc., similar to other embodiments described herein. As shown in FIG. 42, arms 579 extend from elbow 578 at an angle “R” which may generally be less than 180 degrees and preferably less than 90 degrees. Arms 579 extend to elbow 580 and then cross arm 581 (FIG. 39). As shown in FIG. 39, hanger 550 has two side portions connected via cross arm 581. Referring to FIG. 39, a first side portion forms upper component holding section 546A and lower component holding section 546B. The other side portion forms upper component holding section 546A′ and lower component holding section 546B′. The length of cross arm 581 may vary depending on the shape and dimensions of the electrical component or components to be held in the component holding sections and may be in the 1 inch to 6 inch range, more or less. As shown in FIGS. 39 and 40, upper arms 555 extend upward from elbows 556 and flare outward at an angle “T” (FIG. 40). Depending on a particular application, angle “T” may be about 225 degrees or less and preferably about 180 degrees or less. As viewed from above in FIG. 41, arms 553 extend from elbows 554 to end sections 592 formed by arms 553, elbows 552 and finally, hook ends 551. According to this illustrative embodiment, hook ends 551 extend substantially straight out from elbows 552. Of course, the configurations of upper arms 555 and end sections 592 may be formed in any of the various configurations depicted and/or described in any of the embodiments of the present disclosure. As depicted in FIG. 42, arms 553 extend generally parallel to a plane formed by the component holding sections 546A, 546B. The length of arms 553 may vary depending, for example, on the configuration of the frame to which the hanger is to be attached. According to another embodiment of the present disclosure, hook ends 551 may extend outward directly from arms 555 eliminating arms 553 and elbows 552, similar to that described above with respect to the embodiment depicted in FIG. 33A. Such an arrangement would be particularly suitable for hanging hanger 550 from a horizontal frame or rail having connection points (e.g., holes 12, 32) on the underside.

It will be appreciated that hanger 550 may also be suitable for holding excess wiring or cabling. That is, any excess wiring or cabling may be coiled or bundled and held by hanger 550 providing a neat and efficient solution for safely managing such cabling. For example, after the excess wiring or cabling has been coiled, end sections 592 or cross member 581 of hanger 550 may be passed through the coiled wiring or cabling so that the coiled wiring or cabling rests in lower component holding sections 546B, 546B′. One or more electrical components may then be inserted in component holding section 546A, 546A′. The hanger 550 may then be attached to the nearest attachment point on a bracket or frame as described above with respect to the earlier embodiments.

Hanger 550 may be hung from any of the various types of connection points generally found in a rail such as rail 10 depicted in FIG. 43. For example, as described in the present disclosure, hanger 550 may be connected via round holes 32 and oval or slotted holes 12. As shown, a plurality of cables 17 may be neatly held by lower component holding sections 546B, 546B′ of hanger 550. In addition, one or more electrical components may be held in upper component holding sections 546A, 546A′. For example, as shown in FIG. 43, an electrical component 18, at least a portion of which is substantially rectangular in cross-section, may be securely held in upper component holding sections 546A, 546A′. A non-limiting example of such an electrical component is an MC4 connector commonly used in connecting solar panels and which includes a generally rectangular portion. Electrical components are thus neatly supported and held by the upper component holding section with two points of contact (upper component holding sections 546A, 546A′). Electrical components are also neatly supported and securely held by the lower component holding section with two points of contact (lower component holding sections 546B, 546B′) as shown. Furthermore, since the lower component holding sections 546B, 546B′ have a substantially triangular profile (e.g., see FIG. 42) electrical components (e.g., cables or wires) being held in lower component holding sections 546B, 546B′ are arranged substantially in a pyramid, limiting the number of cables being stacked one on top of the other and thus limiting the compressive weight on the cables in the lower part of the pyramid.

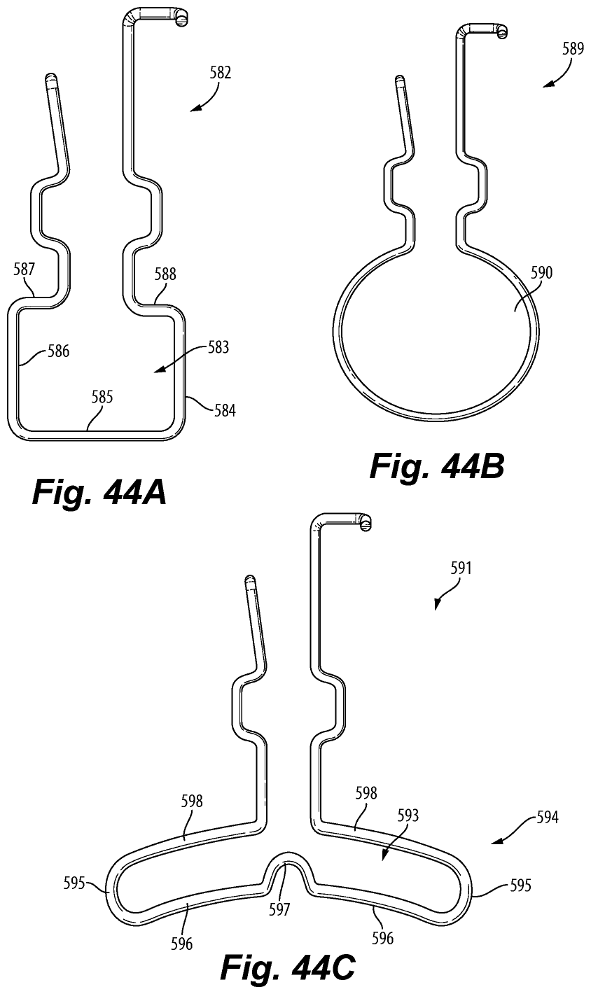

As noted above, the component holding sections of hanger 550 may assume any shape suitable for a particular application. The lower and upper component holding sections may be generally polygonal in shape having any suitable number of sides and may include one or more nonlinear curved sides. For example, as depicted in FIG. 44A, hanger 582 includes a lower component holding section 583 formed by arms 584-588. Although depicted as relatively square, the lower component holding section 583 (as well as the upper component holding section) may assume any polygonal shape. For example, the lengths of arms 584-588 may be selected to provide a horizontal or vertical rectangular shape. One or more or arms 584-588 may assume a shape other than straight. As depicted in FIG. 44B, hanger 589 includes a generally round or oval lower component holding section 590. The upper component holding section may also or alternatively be generally round or oval. Of course, the shapes of various portions of embodiments described herein may be mixed and matched to provide hangers suitable for particular applications. For example, as shown in FIG. 44C, according to an illustrative embodiment of the present disclosure, the hanger 591 may include component holding section 593 similar in shape to component holding section 146 depicted and described with respect to FIG. 33. In particular, component holding section 593 is formed generally in the shape of an oblong or rectangular-like loop 594 formed by upper arms 598, C shaped ends 595, lower arms 596 and middle projection or arced portion 597.

It will be appreciated that a coating similar to that described above with respect to FIG. 15 may be utilized on any of the disclosed embodiments. That is, a coating may be provided on at least the portions of any of the electrical component hangers that come into contact with an electrical component being inserted into electrical the component holding section. Depending on a particular application, the coating may be an electrical insulator and/or may provide a higher coefficient of friction than the material forming the hanger itself. This allows an electrical component being held in the hanger to be electrically isolated from the hanger and any structure upon which the hanger is mounted. Providing a higher coefficient of friction provides a surer grip to hold an electrical component in position. Examples of suitable coatings may include rubber or rubber like materials, plastics, varnish, etc. Coating may be applied to the hanger in any suitable manner including, for example, by brush, spray or dipping, etc.

Certain terminology may be used in the present disclosure for ease of description and understanding. Examples include the following terminology or variations thereof: top, bottom, up, upward, inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings, like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

What is claimed is:

1. An electrical component hanger for securing at least one electrical component to a structure, the electrical component hanger comprising:
at least one connector portion for securing the electrical component hanger to a structure; and
a pair of electrical component receiving portions extending from the at least one connector portion for receiving at least one electrical component to be secured.

2. The electrical component hanger for securing at least one electrical component to a structure according to claim 1, wherein a shape of at least one of the pair of electrical component receiving portions is selected from a group consisting of polygonal, round, square, rectangular and triangular.

3. The electrical component hanger for securing at least one electrical component to a structure according to claim 1, wherein the at least one connector portion comprises a pair of distal end connector portions.

4. The electrical component hanger for securing at least one electrical component to a structure according to claim 3, wherein the distal end connector portions extend from first arms extending between the pair of distal end connector portions and the pair of electrical component receiving portions.

5. The electrical component hanger for securing at least one electrical component to a structure according to claim 4, wherein the distal end connector portions comprise C-shaped hooks.

6. The electrical component hanger for securing at least one electrical component to a structure according to claim 5, wherein the C-shaped hooks extend from the first arms at obtuse angles.

7. The electrical component hanger for securing at least one electrical component to a structure according to claim 6, wherein the first arms extend from the pair of electrical component receiving portions at obtuse angles.

8. The electrical component hanger for securing at least one electrical component to a structure according to claim 4, wherein the distal end connector portions comprise extension arms which extend at substantially right angles from the first arms and distal end arms which extend from the extension arms at substantially right angles.

9. The electrical component hanger for securing at least one electrical component to a structure according to claim 8, wherein each of the pair of electrical component receiving portions comprise first and second component receiving portions.

10. An electrical component hanger comprising:
a segment of spring steel comprising,
a pair of distal end portions capable of deflecting and returning to an original position for securing the electrical component hanger to a structure, and
a middle section extending from the pair of distal end portions and forming an electrical component receiving section for receiving the electrical component to be secured.

11. The electrical component hanger according to claim 10, wherein a shape of the middle section is selected from a group consisting of polygonal, round, square, rectangular and triangular.

12. The electrical component hanger according to claim 10, wherein a shape of the middle section comprises an elongated slot.

13. The electrical component hanger according to claim 12, wherein the middle section comprises arms extending from the pair of distal end portions and the elongated slot extends substantially perpendicularly from the arms.

14. The electrical component hanger according to claim 10, wherein the elongated slot comprises two elongated slots.

15. The electrical component hanger according to claim 14, wherein the two elongated slots are horizontally separated.

16. An electrical component hanger comprising:
a segment of spring steel comprising a pair of distal ends and a middle loop section, the distal ends capable of deflecting and returning to an original position for securing the electrical component hanger to a structure; and
wherein the middle loop section comprises at least one first electrical component receiving section for receiving one or more electrical components and at least one second electrical component receiving section for receiving one electrical component.

17. The electrical component hanger according to claim 16, wherein the at least one first electrical component receiving section forms a lower portion of the electrical component hanger.

18. The electrical component hanger according to claim 17, wherein the at least one second electrical component receiving section is provided between the pair of distal ends and the at least one first electrical component receiving section.

19. The electrical component hanger according to claim 18, wherein the at least one second electrical component receiving section comprises two parallel electrical component receiving sections.

20. The electrical component hanger according to claim 17, wherein the at least one first electrical component receiving section comprises two parallel electrical component receiving sections.
